(19) United States
(12) Patent Application Publication
(10) Pub. No.: US 2016/0203509 A1
(43) Pub. Date: Jul. 14, 2016

(54) Churn Modeling Based On Subscriber Contextual And Behavioral Factors

(71) Applicant: GLOBYS, INC., Seattle, WA (US)

(72) Inventors: Richard Winslow Sharp, III, Seattle, WA (US); Oliver B. Downs, Redmond, WA (US); Jesse S. Hersch, Bellevue, WA (US); Courosh Mehanian, Redmond, WA (US)

(73) Assignee: GLOBYS, INC., Seattle, WA (US)

(21) Appl. No.: 14/596,764

(22) Filed: Jan. 14, 2015

(51) Int. Cl. G06Q 30/02

(52) U.S. Cl. CPC G06Q 30/0244; G06Q 30/0202; G06Q 30/0255

(57) ABSTRACT

Subject innovations are directed towards a churn model using dynamic state-space modeling to determine churn risks for each active subscriber of a service provider having exhibited a precise sequence of behaviors. The churn model identifies complex behavioral patterns that are consistent with those of subscribers who have churned in a defined past, allowing for a personalized determination of churn risk. The churn model may also use static contextual data to assist in refinement of the churn model through identification of subscriber segments. A churn index is produced that may be used by an automated contextual marketing model to refine decision making for selectively marketing to a subscriber based, in part, on that individual subscriber's churn risk.

### TECHNICAL FIELD

The subject innovations disclosed herein relate generally to large data analysis of telecommunications subscribers and, more particularly, but not exclusively, to specialized Churn computer programs using dynamic state-space modeling within a special purpose hardware platform to determine churn risks for each active subscriber having exhibited a sequence of behaviors, and performing contextual marketing to a subscriber based on their churn risk.

### BACKGROUND

The dynamics in today's telecommunications market are placing more pressure than ever on networked services providers to find new ways to compete. With high penetration rates and many services nearing commoditization, many networked service providers have recognized that it is more important than ever to find new ways to bring the full and unique value of the network to their subscribers. In particular, these providers are seeking new solutions to help them more effectively up-sell and/or cross-sell their products, services, content, and applications; successfully launch new products; and create value in new business models.

Many of these activities have been directed towards subscribers who are new to the marketplace as well as convincing subscribers of a competitor to switch. While much of these activities have been successful in terms of obtaining new subscribers, it is becoming more apparent that other providers are also doing similar activities. Thus, while some subscribers may be switching to one provider's products and services, other subscribers may also be dropping that provider's product and services. Since the cost of acquiring a new customer (or wining back an old one) is high, subscriber churn can be a major expense for a networked service provider. The ability to identify and intervene with subscribers who are likely to leave, or otherwise stop using products or services, can have a significant impact on a provider's bottom line. Furthermore, ranking the value of potential messages in support of contextual marketing relies on a rich characterization of a subscriber's state of mind. A subscriber's propensity toward churn adds to this understanding and may help improve messaging effectiveness. Thus, it is with respect to these considerations and others that the present invention has been made.

### BRIEF DESCRIPTION OF THE DRAWINGS

Non-limiting and non-exhaustive embodiments are described with reference to the following drawings. In the drawings, like reference numerals refer to like parts throughout the various figures unless otherwise specified.

For a better understanding, reference will be made to the following Detailed Description, which is to be read in association with the accompanying drawings, wherein:

FIG. 1 is a system diagram of one embodiment of an environment in which the techniques may be practiced;

FIG. 2 shows one embodiment of a client device that may be included in a system implementing the techniques;

FIG. 3 shows one embodiment of a network device that may be included in a system implementing the techniques;

FIG. 4 shows one embodiment of a contextual marketing architecture employing Churn Models Using State-Space Modeling within a contextual marketing platform (CMP);

FIG. 5 shows one embodiment of an intake manager usable within the CMP of FIG. 4;

FIG. 6 shows one embodiment of a common schema manager usable within the CMP of FIG. 4;

FIG. 7 shows one embodiment of the contextual marketing manager usable within the CMP of FIG. 4;

FIG. 8 shows one embodiment of an example of a non-limiting table of common schema account status values useable within the Churn Models;

FIGS. 9-10 show one embodiment of an example of a non-limiting table for common schema attributes for scalars and similar types;

FIG. 11 shows one embodiment of an example of a non-limiting table for common schema attributes for time series types;

FIG. 12 shows one embodiment of a non-limiting, non-exhaustive Churn Model hierarchy;

FIG. 13 shows one embodiment of a non-limiting, non-exhaustive subscriber/customer behavior by activity cluster;

FIG. 14 shows one embodiment of Churn Models useable within the CMP of FIG. 4;

FIG. 15 shows one embodiment of a process flow useable to train Churn and No-Churn Hidden Markov Models (HMM);

FIG. 16 shows one embodiment of a process flow useable to in live production of the trained Churn and No-Churn HMM;

FIG. 17 shows one non-limiting, non-exhaustive example of a timeline of sequences useable by the Churn Models;

FIG. 18 shows one non-limiting, non-exhaustive example of a Receiver Operating Characteristic (ROC) curve useable with a Churn Component; and

FIG. 19 shows one non-limiting, non-exhaustive example of several time series type data sequences useable for creating sequences by the Churn Models.

### DETAILED DESCRIPTION

The present techniques now will be described more fully hereinafter with reference to the accompanying drawings, which form a part hereof, and which show, by way of illustration, specific embodiments by which the subject innovations may be practiced. The subject innovations may, however, be embodied in many different forms and should not be construed as limited to the embodiments set forth herein; rather, these embodiments are provided so that this disclosure will be thorough and complete, and will fully convey the scope of the innovations to those skilled in the art. Among other things, the subject innovations may be embodied as methods or devices. Accordingly, the subject innovations may take the form of an entirely hardware embodiment, an entirely software embodiment or an embodiment combining software and hardware aspects. The following detailed description is, therefore, not to be taken in a limiting sense.

Throughout the specification and claims, the following terms take the meanings explicitly associated herein, unless the context clearly dictates otherwise. The various occurrences of the phrase “in one embodiment” as used herein do not necessarily refer to the same embodiment, though they may. As used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As used herein, the terms “customer,” “user,” and “subscriber” may be used interchangeably to refer to an entity that has or is predicted to in the future make a procurement of a product, service, content, and/or application from another entity. As such, customers include not just an individual or a family, but also businesses, organizations, or the like. Further, as used herein, the term “entity” refers to a customer, subscriber, user, or the like. In one embodiment, an entity may also be a subscriber telecommunications line or simply, a subscriber line.

As used herein, the terms “networked services provider”, “telecommunications”, “telecom”, “provider”, “carrier”, “telecommunications service provider,” and “operator” may be used interchangeably to refer to a provider of any network-based telecommunications media, product, service, content, and/or application, whether inclusive of or independent of the physical transport medium that may be employed by the telecommunications media, products, services, content, and/or application. As used herein, references to “products/services,” or the like, are intended to include products, services, content, and/or applications, and is not to be construed as being limited to merely “products and/or services.” Further, such references may also include scripts, or the like.

As used herein, the terms “optimized” and “optimal” refer to a solution that is determined to provide a result that is considered closest to a defined criteria or boundary given one or more constraints to the solution. Thus, a solution is considered optimal if no other solution provides a more favorable or desirable result, under some restriction, compared to other determined solutions. An optimal solution therefore, is a solution selected from a set of determined solutions.

As used herein, the terms “offer” and “offering” refer to a networked services provider's product, service, content, and/or application for purchase by a customer. In one embodiment, an offer may be viewed as a stated condition to be met by a customer or subscriber in exchange for an incentive. However, it is possible that the condition to be met is merely to hold an account with the carrier or that the value of the incentive is negligible in a monetary sense. Examples may include a “giveaway” or “informational” offer. An offer or offering may be presented to the customer (user) using any of a variety of mechanisms. Thus, the offer or offering may be independent of the mechanism by which the offer or offering is presented.

As used herein, the term “message” refers to a mechanism for transmitting an offer or offering. Typically, the offer or offering is embedded within a message having a variety of fields. The fields may include how the message is presented, when the message is presented, or the like. Thus, in some embodiments, a field of a message having the offer may include the mechanism in which the offer is presented. For example, in some embodiments, a message having the offer may be selected to be sent to a user/customer based on a field for how the offer is presented (e.g., voice, IM, SMS, email, or the like), or when it is presented.

As used herein, the term “event” refers to a piece of information that has an associated point in time and relates to an entity. As one non-limiting, non-exhaustive example, an account recharge may be considered as an event. While events are realized at a point in time, they may reflect actions realized over an interval of time, such as having recharged at least once in the last 30 days, realized daily. Another example is a churn event, which is often defined as a lack of activity over a period of time, but realized at the beginning of the interval during which dependent criteria are met (and as such, cannot be measured until some significant time after the occurrence of the event). Events may be delivered to the platform described herein, via a telecommunications service provider as customer specific events; be defined based on a mapping of customer specific events; be defined by processes within the CMP; or the like.

As used herein, the term “attribute” refers to a characteristic that can be computed or otherwise obtained about one or more entities, messages, or other item. User attributes, include, but are not limited to, a user's age; a geographic location of the user; an income status of the user; a usage plan; a plan identifier (ID); a refresh rate for the plan; a user propensity (e.g., a propensity to perform an action, or so forth) or the like. Attributes may also include or otherwise represent information about user clusters, including recharge (of a mobile device) time series clusters, usage histogram clusters, cluster scoring, or the like. Thus, attributes may include a variety of information about users. In some embodiments, the attributes may have discrete values, continuous values, values constituting a category, cyclical and ordered discrete values, values of complex types such as time series or histograms, or the like. Moreover, some attributes may be derived from other attributes. In some embodiments, a user might not be associated with at least one attribute (missing attribute) for which a value is available for another user. The set of attributes about an entity may be combined to create a set of attributes herein termed a “state vector.”

The following briefly describes the subject innovations in order to provide a basic understanding of some aspects of the techniques. This brief description is not intended as an extensive overview. It is not intended to identify key or critical elements, or to delineate or otherwise narrow the scope. Its purpose is merely to present some concepts in a simplified form as a prelude to the more detailed description that is presented later.

Briefly stated, subject innovations are disclosed herein that are directed towards at least a specialized Churn model using dynamic state-space modeling within a special purpose hardware platform to determine churn risks for each active subscriber having exhibited a sequence of behaviors. As discuss further below, the specialized churn model determines churn risk for each of a provider's active subscribers based on a sequence of recent actions taken by the subscriber. The churn model identifies complex behavioral patterns that are consistent with those of subscribers who have churned in a defined past, and does so in a tailored way for distinct segments of an overall subscriber base. The churn model does not simply identify broad based behavioral trends, rather, the churn model allows for a personalized churn assessment: a subscriber is not treated as a member of a large class (e.g., males who recharge weekly), but as an individual who has exhibited a precise sequence of behaviors. Furthermore, churn models are integrated with a closed loop contextual marketing system that uses the churn risk assessment produced by the churn models to learn subscriber behavior and optimize marketing campaigns designed to improve performance of certain Key Performance Indicators (KPIs) for a carrier.

Moreover, as noted, the churn model makes use of sequential behavior rather than a traditional aggregate approach. That is, the sequential nature of events is an inherent part of the churn model, rather than an ad hoc approximation. The disclosed churn model may also take advantage of (potentially static) contextual data to improve performance by segmenting subscribers and building individual behavioral sub-models for each segment. Thus, taken together, the subject innovations are directed towards a novel personalized approach to modeling of subscribers. Subscribers are not simply assigned to a large class and associated with a churn behavior of that class, rather, each subscriber's individual context and behavior is assessed by the churn model to determine a score signaling the likelihood that a subscriber will churn.

The churn model further employs dynamic social network features to construct the behavioral sequence of an individual subscriber. In contrast to other approaches which might make use of only static (or slowly changing) features of the network, such as the size of a subscriber's ego network, the disclosed churn model also makes use of dynamic features such as the sequence of daily activity on the ego network.

Some embodiments of the disclosed churn model also make use of wavelet filtering applied to quantized variables for producing behavioral sequences or to produce an objective (parameter free) approach for determining activity filter thresholds used to determine eligibility for churn scoring. The disclosed churn model is also directed towards being robust in the sense that it uses what is herein referred to as common schema data to make it readily adaptable to new telecommunications providers. That is, the disclosed churn model does not need to start from “scratch” when a provider first presents its data to the churn model. Instead, the disclosed churn model is directed towards working with common schema items that are expected to be widely available from telecommunications providers.

The churn model is also directed towards being flexible in the sense that it can be easily enriched with additional behavioral or contextual data. Each provider may have some data that can improve the churn model, but is unlikely to be widely available amongst other providers. Other data that has been ingested into the disclosed Contextual Marketing platform, described further below, may be added to the churn model and evaluated in an attempt to improve performance over other traditional approaches.

In some embodiments, the churn index may serve multiple purposes, informing both the automated contextual marketing function of the system and human marketers and data scientists. As disclosed further below, the churn index is a feature that can be used by the automated contextual marketing model to refine decision making for selectively marketing to a subscriber. Moreover, the churn index may also be incorporated into automated monitoring of the performance of the contextual marketing systems or its components. The churn index may also be available to human marketers and data scientists who might want to interact with the system. However, it should be understood that some embodiments operate automatically, absent such human interactions.

As disclosed elsewhere, the churn model may be highly configurable. For example, in some embodiments, the definition of churn is parameterized. This means that in addition to having multiple churn models for various segments of the subscriber base, there can also be parallel churn models on the same segment with different churn definitions (or other settings). This is then directed towards an automated marketing model that may be able to determine which definition to use for a defined best message targeting, while marketers and others working with the model may find different definitions more useful for constructing campaigns and reports.

It is noted that while embodiments herein disclose applications to telecommunications subscribers, where the subscribers are different from the telecommunications providers, other intermediate entities may also benefit from the subject innovations disclosed herein. For example, banking industries, cable television industries, retailers, wholesalers, or virtually any other industry in which that industry's customers interact with the services and/or products offered by an entity within that industry.

### Illustrative Operating Environment

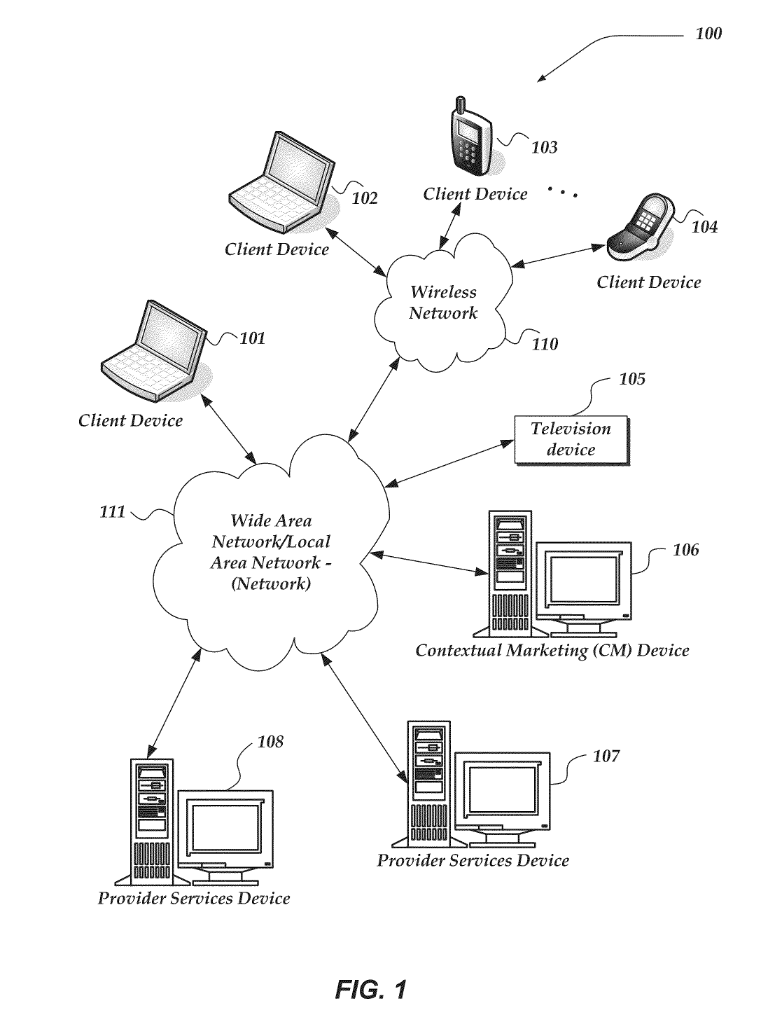

FIG. 1 shows components of one embodiment of an environment in which the invention may be practiced. Not all the components may be required to practice the invention, and variations in the arrangement and type of the components may be made without departing from the spirit or scope of the subject innovations. As shown, system 100 of FIG. 1 includes local area networks (“LANs”)/wide area networks (“WANs”)—(network) 111, wireless network 110, client devices 101-105, Contextual Marketing (CM) device 106, and provider services 107-108.

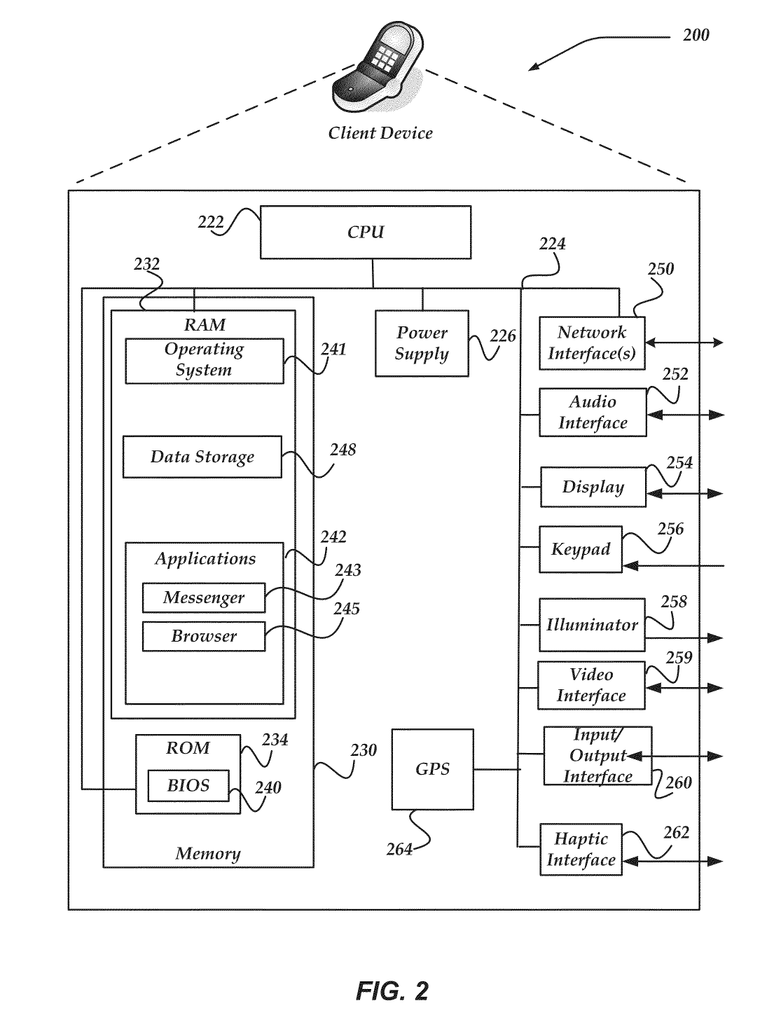

One embodiment of a client device usable as one of client devices 101-105 is described in more detail below in conjunction with FIG. 2. Generally, however, client devices 102-104 may include virtually any computing device capable of receiving and sending a message over a network, such as wireless network 110, wired networks, satellite networks, virtual networks, or the like. Such devices include wireless devices such as, cellular telephones, smart phones, display pagers, radio frequency (RF) devices, infrared (IR) devices, Personal Digital Assistants (PDAs), handheld computers, laptop computers, wearable computers, tablet computers, integrated devices combining one or more of the preceding devices, or the like. Client device 101 may include virtually any computing device that typically connects using a wired communications medium such as telephones, televisions, video recorders, cable boxes, gaming consoles, personal computers, multiprocessor systems, microprocessor-based or programmable consumer electronics, network PCs, or the like. Further, as illustrated, client device 105 represents one embodiment of a client device operable as a television device. In one embodiment, client device 105 may also be portable. In one embodiment, one or more of client devices 101-105 may also be configured to operate over a wired and/or a wireless network.

Client devices 101-105 typically range widely in terms of capabilities and features. For example, a cell phone may have a numeric keypad and a few lines of monochrome LCD display on which only text may be displayed. In another example, a web-enabled client device may have a touch sensitive screen, a stylus, and several lines of color display in which both text and graphics may be displayed.

A web-enabled client device may include a browser application that is configured to receive and to send web pages, web-based messages, or the like. The browser application may be configured to receive and display graphics, text, multimedia, or the like, employing virtually any web-based language, including a wireless application protocol messages (WAP), or the like. In one embodiment, the browser application is enabled to employ Handheld Device Markup Language (HDML), Wireless Markup Language (WML), WMLScript, JavaScript, Standard Generalized Markup Language (SMGL), HyperText Markup Language (HTML), eXtensible Markup Language (XML), or the like, to display and send information.

Client devices 101-105 also may include at least one other client application that is configured to receive information and other data from another computing device. The client application may include a capability to provide and receive textual content, multimedia information, audio information, or the like. The client application may further provide information that identifies itself, including a type, capability, name, or the like. In one embodiment, client devices 101-105 may uniquely identify themselves through any of a variety of mechanisms, including a phone number, Mobile Station International Subscriber Directory Number (MSISDN), Mobile Identification Number (MIN), an electronic serial number (ESN), mobile device identifier, network address, or other identifier. The identifier may be provided in a message, or the like, sent to another computing device.

In one embodiment, client devices 101-105 may further provide information useable to detect a location of the client device. Such information may be provided in a message, or sent as a separate message to another computing device.

Client devices 101-105 may also be configured to communicate a message, such as through email, Short Message Service (SMS), Multimedia Message Service (MMS), Instant Messaging (IM), Internet Relay Chat (IRC), Mardam-Bey's IRC (mIRC), Jabber, or the like, between another computing device. However, the present invention is not limited to these message protocols, and virtually any other message protocol may be employed.

Client devices 101-105 may further be configured to include a client application that enables the user to log into a user account that may be managed by another computing device. Information provided either as part of a user account generation, a purchase, or other activity may result in providing various customer profile information. Such customer profile information may include, but is not limited to purchase history, current telecommunication plans about a customer, and/or behavioral information about a customer and/or a customer's activities, including data that may come from publically available sources in addition to the provider's private data.

Wireless network 110 is configured to couple client devices 102-104 with network 111. Wireless network 110 may include any of a variety of wireless sub-networks that may further overlay stand-alone ad hoc networks, or the like, to provide an infrastructure-oriented connection for client devices 102-104. Such sub-networks may include mesh networks, Wireless LAN (WLAN) networks, cellular networks, or the like.

Wireless network 110 may further include an autonomous system of terminals, gateways, routers, or the like connected by wireless radio links, or the like. These connectors may be configured to move freely and randomly and organize themselves arbitrarily, such that the topology of wireless network 110 may change rapidly.

Wireless network 110 may further employ a plurality of access technologies including 2nd (2G), 3rd (3G), 4th (4G) generation radio access for cellular systems, WLAN, Wireless Router (WR) mesh, or the like. Access technologies such as 2G, 2.5G, 3G, 4G, and future access networks may enable wide area coverage for client devices, such as client devices 102-104 with various degrees of mobility. For example, wireless network 110 may enable a radio connection through a radio network access such as Global System for Mobile communication (GSM), General Packet Radio Services (GPRS), Enhanced Data GSM Environment (EDGE), Wideband Code Division Multiple Access (WCDMA), Bluetooth, or the like. Further, wireless network 110 may be configured to enable use of a short message service center (SMSC) as a network element in a mobile telephone network, within wireless network 110. Thus, wireless network 110 enables the storage, forwarding, conversion, and delivery of SMS messages. In essence, wireless network 110 may include virtually any wireless communication mechanism by which information may travel between client devices 102-104 and another computing device, network, or the like.

Network 111 couples CM device 106, provider service devices 107-108, and client devices 101 and 105 with other computing devices, and allows communications through wireless network 110 to client devices 102-104. Network 111 is enabled to employ any form of computer readable media for communicating information from one electronic device to another. Also, network 111 can include the Internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router may act as a link between LANs, enabling messages to be sent from one to another. In addition, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. Furthermore, remote computers and other related electronic devices could be remotely connected to either LANs or WANs via a modem and temporary telephone link. In essence, network 111 includes any communication method by which information may travel between computing devices.

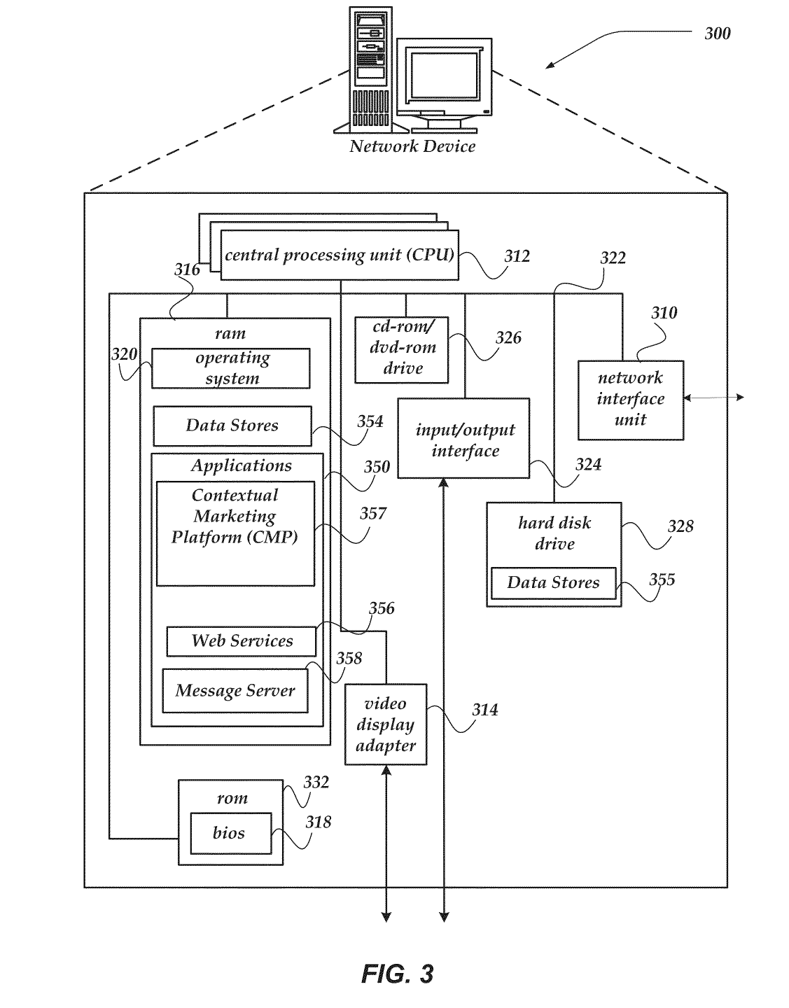

One embodiment of CM device 106 is described in more detail below in conjunction with FIG. 3. Briefly, however, CM device 106 includes virtually any network computing device that is specially configured to proactively and contextually target offers to selected subscribers based in part on churn models employing state-space modeling that determine churn risks for each subscriber having exhibited a sequence of behaviors.

Devices that may operate as CM device 106 include, but are not limited to personal computers, desktop computers, multiprocessor systems, microprocessor-based or programmable consumer electronics, network PCs, servers, network appliances, and the like.

Although CM device 106 is illustrated as a distinct network device, the invention is not so limited. For example, a plurality of network devices may be configured to perform the operational aspects of CM device 106. For example, data collection might be performed by one or more set of network devices, while managing marketing and/or developing and employing the herein disclosed innovative churn models may be performed by one or more other network devices.

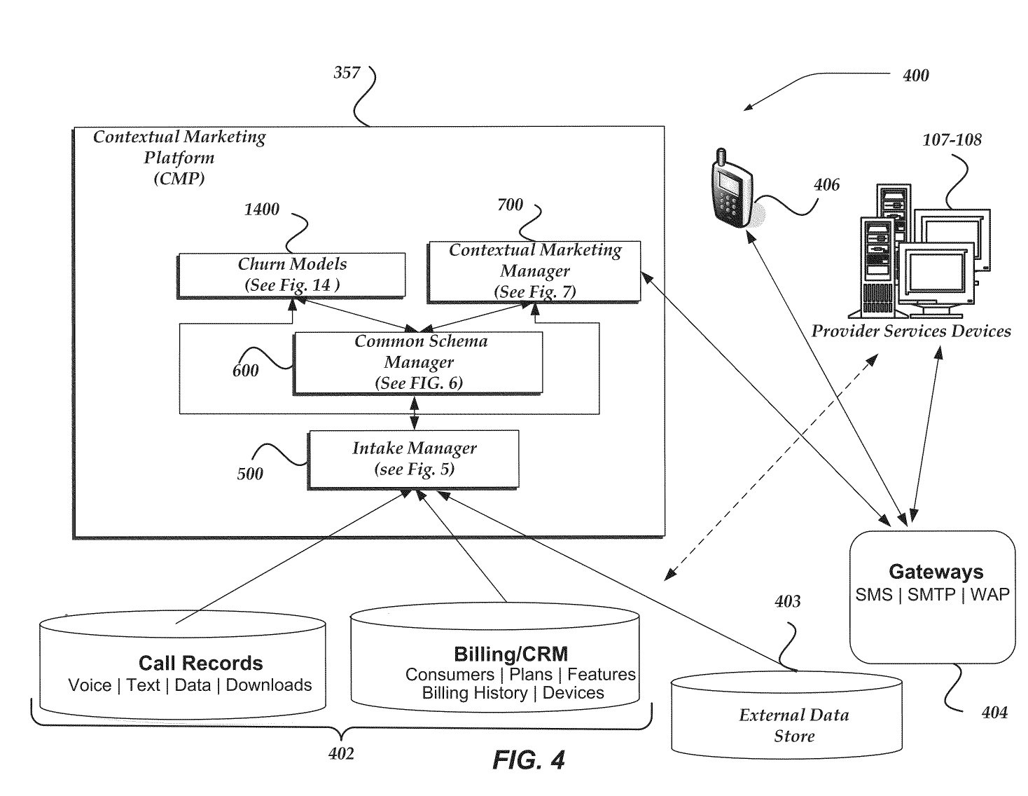

Provider service devices 107-108 include virtually any network computing device that is configured to provide to CM device 106 information including networked services provider information, customer information, and/or other context information, including, but not limited to external user information such as data widely published via the Internet, for example public postings on social networking web sites, or so forth, for use in generating and selectively presenting a customer with targeted offers based on this. In some embodiments, provider service devices 107-108 may provide various interfaces, including, but not limited to those described in more detail below in conjunction with FIG. 4.

### Illustrative Client Environment

FIG. 2 shows one embodiment of client device 200 that may be included in a system implementing the invention. Client device 200 may include many more or less components than those shown in FIG. 2. However, the components shown are sufficient to disclose an illustrative embodiment for practicing the present invention. Client device 200 may represent, for example, one of client devices 101-105 of FIG. 1.

As shown in the figure, client device 200 includes a central processing unit (CPU) 222 in communication with a mass memory 230 via a bus 224. Client device 200 also includes a power supply 226, one or more network interfaces 250, an audio interface 252, video interface 259, a display 254, a keypad 256, an illuminator 258, an input/output interface 260, a haptic interface 262, and an optional global positioning systems (GPS) receiver 264. Power supply 226 provides power to client device 200. A rechargeable or non-rechargeable battery may be used to provide power. The power may also be provided by an external power source, such as an AC adapter or a powered docking cradle that supplements and/or recharges a battery.

Client device 200 may optionally communicate with a base station (not shown), or directly with another computing device. Network interface 250 includes circuitry for coupling client device 200 to one or more networks, and is constructed for use with one or more communication protocols and technologies including, but not limited to, global system for mobile communication (GSM), code division multiple access (CDMA), time division multiple access (TDMA), user datagram protocol (UDP), transmission control protocol/Internet protocol (TCP/IP), SMS, general packet radio service (GPRS), WAP, ultra wide band (UWB), IEEE 802.16 Worldwide Interoperability for Microwave Access (WiMax), SIP/RTP, Bluetooth™, infrared, Wi-Fi, Zigbee, or any of a variety of other wireless communication protocols. Network interface 250 is sometimes known as a transceiver, transceiving device, or network interface card (NIC).

Audio interface 252 is arranged to produce and receive audio signals such as the sound of a human voice. For example, audio interface 252 may be coupled to a speaker and microphone (not shown) to enable telecommunication with others and/or generate an audio acknowledgement for some action. Display 254 may be a liquid crystal display (LCD), gas plasma, light emitting diode (LED), or any other type of display used with a computing device. Display 254 may also include a touch sensitive screen arranged to receive input from an object such as a stylus or a digit from a human hand.

Video interface 259 is arranged to capture video images, such as a still photo, a video segment, an infrared video, or the like. For example, video interface 259 may be coupled to a digital video camera, a web-camera, or the like. Video interface 259 may comprise a lens, an image sensor, and other electronics. Image sensors may include a complementary metal-oxide-semiconductor (CMOS) integrated circuit, charge-coupled device (CCD), or any other integrated circuit for sensing light.

Keypad 256 may comprise any input device arranged to receive input from a user. For example, keypad 256 may include a push button numeric dial, or a keyboard. Keypad 256 may also include command buttons that are associated with selecting and sending images. Illuminator 258 may provide a status indication and/or provide light. Illuminator 258 may remain active for specific periods of time or in response to events. For example, when illuminator 258 is active, it may backlight the buttons on keypad 256 and stay on while the client device is powered. Also, illuminator 258 may backlight these buttons in various patterns when particular actions are performed, such as dialing another client device. Illuminator 258 may also cause light sources positioned within a transparent or translucent case of the client device to illuminate in response to actions.

Client device 200 also comprises input/output interface 260 for communicating with external devices, such as a headset, or other input or output devices not shown in FIG. 2. Input/output interface 260 can utilize one or more communication technologies, such as USB, infrared, Bluetooth™, Wi-Fi, Zigbee, or the like. Haptic interface 262 is arranged to provide tactile feedback to a user of the client device. For example, the haptic interface may be employed to vibrate client device 200 in a particular way when another user of a computing device is calling.

Optional GPS transceiver 264 can determine the physical coordinates of client device 200 on the surface of the Earth, which typically outputs a location as latitude and longitude values. GPS transceiver 264 can also employ other geo-positioning mechanisms, including, but not limited to, triangulation, assisted GPS (AGPS), E-OTD, CI, SAI, ETA, BSS or the like, to further determine the physical location of client device 200 on the surface of the Earth. It is understood that under different conditions, GPS transceiver 264 can determine a physical location within millimeters for client device 200; and in other cases, the determined physical location may be less precise, such as within a meter or significantly greater distances. In one embodiment, however, a client device may through other components, provide other information that may be employed to determine a physical location of the device, including for example, a MAC address, IP address, or the like.

Mass memory 230 includes a RAM 232, a ROM 234, and other storage means. Mass memory 230 illustrates another example of computer readable storage media for storage of information such as computer readable instructions, data structures, program modules, or other data. Computer readable storage media may include volatile, nonvolatile, removable, and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computing device.

Mass memory 230 stores a basic input/output system (“BIOS”) 240 for controlling low-level operation of client device 200. The mass memory also stores an operating system 241 for controlling the operation of client device 200. It will be appreciated that this component may include a general-purpose operating system such as a version of UNIX, or LINUX™, or a specialized client operating system, for example, such as Windows Mobile™, PlayStation 3 System Software, the Symbian® operating system, Android, Blackberry, iOS, or the like. The operating system may include, or interface with a Java virtual machine module that enables control of hardware components and/or operating system operations via Java application programs.

Memory 230 further includes one or more data storage 248, which can be utilized by client device 200 to store, among other things, applications 242 and/or other data. For example, data storage 248 may also be employed to store information that describes various capabilities of client device 200, as well as store an identifier. The information, including the identifier, may then be provided to another device based on any of a variety of events, including being sent as part of a header during a communication, sent upon request, or the like. In one embodiment, the identifier and/or other information about client device 200 might be provided automatically to another networked device, independent of a directed action to do so by a user of client device 200. Thus, in one embodiment, the identifier might be provided over the network transparent to the user.

Moreover, data storage 248 may also be employed to store personal information including but not limited to contact lists, personal preferences, purchase history information, use information that might include how and/or when a product or service is used, user demographic information, behavioral information, or the like. At least a portion of the information may also be stored on a disk drive or other storage medium (not shown) within client device 200.

Applications 242 may include computer executable instructions which, when executed by client device 200, transmit, receive, and/or otherwise process messages (e.g., SMS, MMS, IM, email, and/or other messages), multimedia information, and enable telecommunication with another user of another client device. Other examples of application programs include calendars, browsers, email clients, IM applications, SMS applications, VOIP applications, contact managers, task managers, transcoders, database programs, word processing programs, security applications, spreadsheet programs, games, search programs, and so forth. Applications 242 may include, for example, messenger 243, and browser 245.

Browser 245 may include virtually any client application configured to receive and display graphics, text, multimedia, and the like, employing virtually any web based language. In one embodiment, the browser application is enabled to employ Handheld Device Markup Language (HDML), Wireless Markup Language (WML), WMLScript, JavaScript, Standard Generalized Markup Language (SMGL), HyperText Markup Language (HTML), eXtensible Markup Language (XML), and the like, to display and send a message. However, any of a variety of other web-based languages may also be employed.

Messenger 243 may be configured to initiate and manage a messaging session using any of a variety of messaging communications including, but not limited to email, Short Message Service (SMS), Instant Message (IM), Multimedia Message Service (MMS), Internet Relay Chat (IRC), mIRC, and the like. For example, in one embodiment, messenger 243 may be configured as an IM application, such as AOL Instant Messenger, Yahoo! Messenger, .NET Messenger Server, ICQ, or the like. In one embodiment messenger 243 may be configured to include a mail user agent (MUA) such as Elm, Pine, MH, Outlook, Eudora, Mac Mail, Mozilla Thunderbird, or the like. In another embodiment, messenger 243 may be a client application that is configured to integrate and employ a variety of messaging protocols. Messenger 243, browser 245, or other communication mechanisms that may be employed by a user of client device 200 to receive selectively targeted offers of a product/service based on selection process described in more detail below.

### Illustrative Network Device Environment

FIG. 3 shows one embodiment of a network device, according to one embodiment of the invention. Network device 300 may include many more components than those shown. The components shown, however, are sufficient to disclose an illustrative embodiment for practicing the invention. Network device 300 may represent, for example, CM device 106 of FIG. 1.

Network device 300 includes one or more central processing unit (CPU) 312, video display adapter 314, and a mass memory, all in communication with each other via bus 322. The mass memory generally includes RAM 316, ROM 332, and one or more permanent (non-transitory) mass storage devices, such as hard disk drive 328, tape drive, optical drive, and/or floppy disk drive. The mass memory stores operating system 320 for controlling the operation of network device 300. Any general-purpose operating system may be employed. Basic input/output system (“BIOS”) 318 is also provided for controlling the low-level operation of network device 300. As illustrated in FIG. 3, network device 300 also can communicate with the Internet, or some other communications network, via network interface unit 310, which is constructed for use with various communication protocols including the TCP/IP protocol. Network interface unit 310 is sometimes known as a transceiver, transceiving device, or network interface card (NIC).

The mass memory as described above illustrates another type of non-transitory computer-readable device, namely physical computer storage devices. Computer readable storage devices may include volatile, nonvolatile, removable, and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transitory, physical devices which can be used to store the desired information and which can be accessed by a computing device.

The mass memory also stores program code and data. For example, mass memory might include data store 354. Data store 354 may be include virtually any mechanism usable for store and managing data, including but not limited to a file, a folder, a document, or an application, such as a database, spreadsheet, or the like. Data store 354 may manage information that might include, but is not limited to web pages, information about customers to a telecommunications service provider, identifiers, profile information, event data, behavioral data, state vectors, business and/or marketing rules, constraints, churn model data, reports, and any of a variety of data associated with a user, message, and/or marketer, as well as scripts, applications, applets, and the like. It is noted that while data stores 354 are illustrated within memory 316, data stores 354 may also be stored in other locations within network device 300, including but not limited to cd-rom/dvd-rom drive 326, hard disk drive 328, or even on another network device similar to network device 300. Moreover, data may be distributed across a plurality of data stores such as data stores 354 and/or 355.

One or more applications 350 may be loaded into mass memory and run on operating system 320 using CPU 312. Examples of application programs may include transcoders, schedulers, calendars, database programs, word processing programs, HTTP programs, customizable user interface programs, IPSec applications, encryption programs, security programs, VPN programs, web servers, account management, games, media streaming or multicasting, and so forth. Applications 350 may include web services 356, Message Server (MS) 358, and Contextual Marketing Platform (CMP) 357.

Web services 356 represent any of a variety of services that are configured to provide content, including messages, over a network to another computing device. Thus, web services 356 include for example, a web server, messaging server, a File Transfer Protocol (FTP) server, a database server, a content server, or the like. Web services 356 may provide the content including messages over the network using any of a variety of formats, including, but not limited to WAP, HDML, WML, SMGL, HTML, XML, cHTML, xHTML, or the like. In one embodiment, web services 356 might interact with CMP 357 to enable a networked services provider to track customer behavior, and/or provide contextual offerings based in part on determining a churn risk for a given subscriber having a defined sequence of behaviors.

Message server 358 may include virtually any computing component or components configured and arranged to forward messages from message user agents, and/or other message servers, or to deliver messages to a local message store, such as data stores 354-355, or the like. Thus, message server 358 may include a message transfer manager to communicate a message employing any of a variety of email protocols, including, but not limited, to Simple Mail Transfer Protocol (SMTP), Post Office Protocol (POP), Internet Message Access Protocol (IMAP), NNTP, Session Initiation Protocol (SIP), or the like.

However, message server 358 is not constrained to email messages, and other messaging protocols may also be managed by one or more components of message server 358. Thus, message server 358 may also be configured to manage Short Message Service (SMS) messages, IM, MMS, IRC, mIRC, or any of a variety of other message types. In one embodiment, message server 358 may also be configured to interact with CMP 357 and/or web services 356 to provide various communication and/or other interfaces useable to receive provider, customer, and/or other information useable to determine and/or provide contextual customer offers.

However, it should be noted that messages may be provided to a customer service call center, where the messages may be outbound communicated to a customer, for example, by a human being, or be integrated into an inbound conversation between a customer and an agent. The messages, may, for example, take the form of a display advertising message shown on a service provider's customer portal, or in a user's browser on their client device. Moreover, messages may also be sent using any of a variety of protocols to the client device, including, but not limited, for example, via Unstructured Supplementary Service Data (USSD).

One embodiment of CMP 357 is described in more detail below in conjunction with FIGS. 4-18. However, briefly, CMP 357 is configured to receive various historical and behavioral data from networked services providers about their customers, including customer profiles, billing records, usage data, purchase data, types of mobile devices, and the like. Such data may be referred to herein as “raw data.” At least some of the received data may then be mapped to a common schema. CMP 357 may then employ the below disclosed churn models based on the common schema. CMP 357 may further employ a contextual marketing manager, as discussed further below, to generate messaging decisions that determine which customers will receive which messages and when. By using the disclosed churn models the contextual marketing manager may take churn risk into account when sending an offer or other type of message to a customer.

### Illustrative Architecture

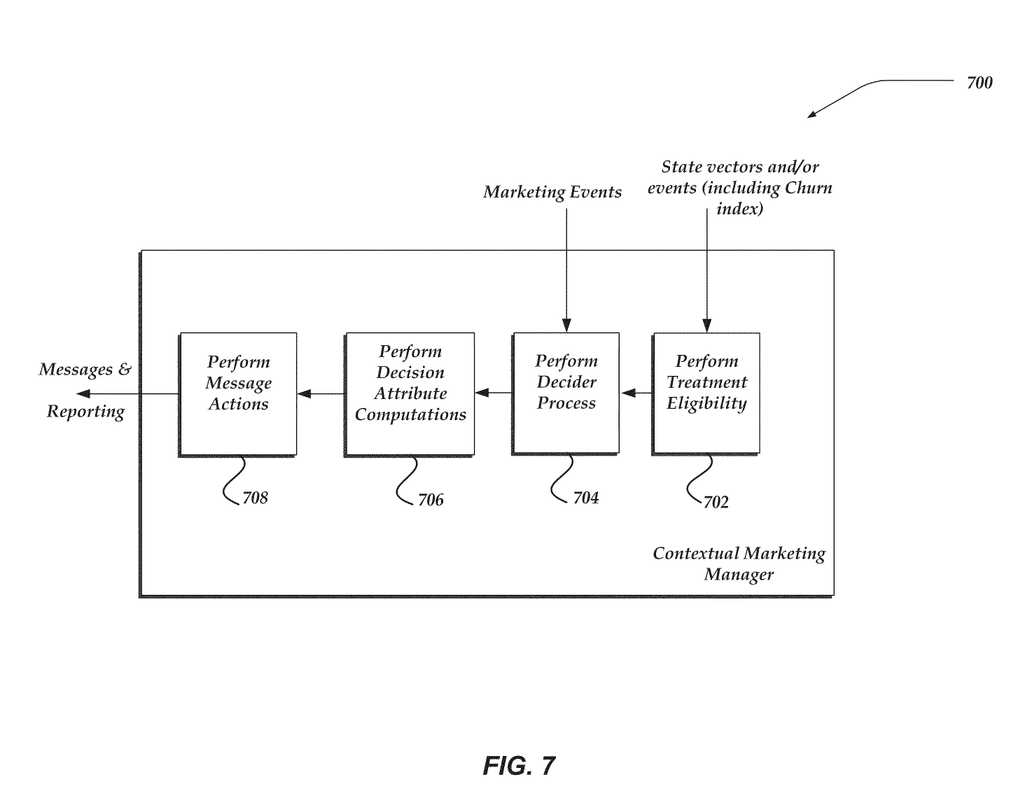

FIG. 4 shows one embodiment of an architecture 400 useable to perform contextual marketing of offers to customers, where the offers have been designed to actively test and improve the targeting of a myriad of marketing messages across a carrier's subscriber base. Briefly, the Contextual Marketing Platform 357 ingests raw data from carriers, and potentially from external sources, and maps the data to a common schema. Various Churn models are employed that enable the Contextual Marketing Manager 700 described in FIG. 7 to take churn risk of each subscriber into account when generating its contextual offers.

Architecture 400 of FIG. 4 may include many more components than those shown. The components shown, however, are sufficient to disclose an illustrative embodiment for practicing the invention. Architecture 400 may be deployed across components of FIG. 1, including, for example, CM device 106, client devices 101-105, and/or provider services 107-108.

Not all the components shown in FIG. 4 may be required to practice the invention and variations in the arrangement and type of the components may be made without departing from the spirit or scope of the subject innovation. As shown, however, architecture 400 includes a CMP 357, networked services provider (NSP) data stores 402 and external data stores 403, communication channel or communication channels 404, and client device 406.

Client device 406 represents a client device, such as client devices 101-105 described above in conjunction with FIGS. 1-2. NSP data stores 402 may be implemented within one or more services 107-108 of FIG. 1. As shown, NSP data stores 402 may include a Billing/Customer Relationship Management (CRM) data store, and a Network Usage Records data store. However, the subject innovation is not limited to this information, and other types of data from networked services providers may also be used. The Billing/CRM data may be configured to provide such historical data as a customer's profile, including their billing history, customer service plan information, service subscriptions, feature information, content purchases, client device characteristics, and the like. Usage Records may provide various historical data as well as current data including but not limited to network usage record information including voice, text, Internet, download information, media access, product and/or service use behaviors, and the like. NSP data stores 402 may also provide information about a time when such communications occur, as well as a physical location for which a customer might be connected to during a communication, and information about the entity to which a customer is connecting. Such physical location information may be determined using a variety of mechanisms, including, for example, identifying a cellular station that a customer is connected to during the communication. From such connection location information, an approximate geographic or relative location of the customer may be determined. NSP data may further provide information about whether a user received an offer (treatment), and whether or not they responded to that offer (treatment), when, and how. Thus, NSP data may provide data usable to determine a feature measure's value, directly or indirectly.

CMP 357 may also receive data from external data stores 403. External data stores 403 may include virtually any mechanism usable for storing and managing data, including but not limited to files stored on disk, an application, such as a database or spreadsheet, a web service, or the like. External data sources 403 may provide, but is not limited to, publically available information about a carrier's customers including identifiers, demographic information, public postings on social networking web sites, or the like. In addition to data generated by or relating to a specific subscriber, external data stores 403 may also provide contextual information that is broadly applicable to a wide range of customers, such as, but not limited to, a schedule of events relevant to a geographic area, offers or promotions from competing carriers within a region, or the like.

CMP 357 is streamlined to quickly receive and process the incoming data through various data cycles. As the raw data is processed into state vectors of attributes, treatment eligibilities, ranking models, distribution data, and other supporting data, the raw data, and/or results of the processing on the raw data may be stored for later use. However, it should be noted that CMP 357 is configured not to leave any event transactional data ‘on the floor.’ Rather, CMP 357 is directed towards being capable of analyzing data that may not appear in a common set, but appears in a particular case, so that unanticipated actions or results may also be employed and used to further adapt the system. CMP 357 is also directed towards being capable of analyzing historic data so that unanticipated insights may also be employed and used to further adapt the system.

Communication channels 404 include one or more components that are configured to enable network devices to deliver and receive interactive communications with a customer. In one embodiment, communication channels 404 may be implemented within one or more of provider services 107-108, and/or client devices 101-105 of FIG. 1, and/or within networks 110 and/or 111 of FIG. 1.

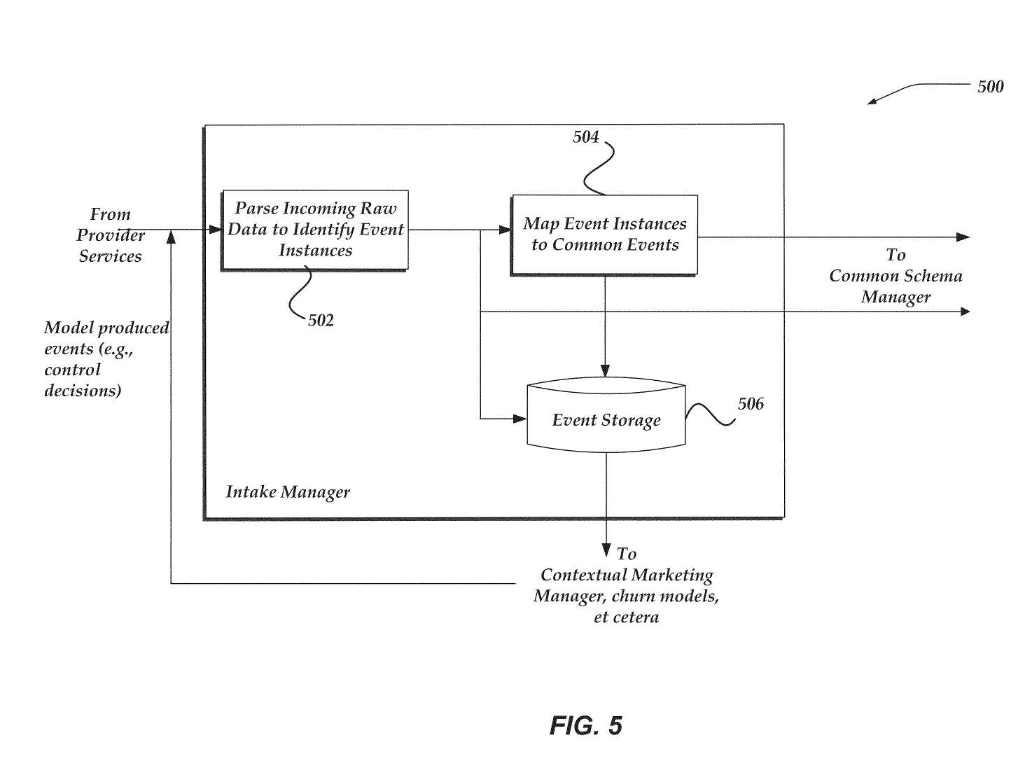

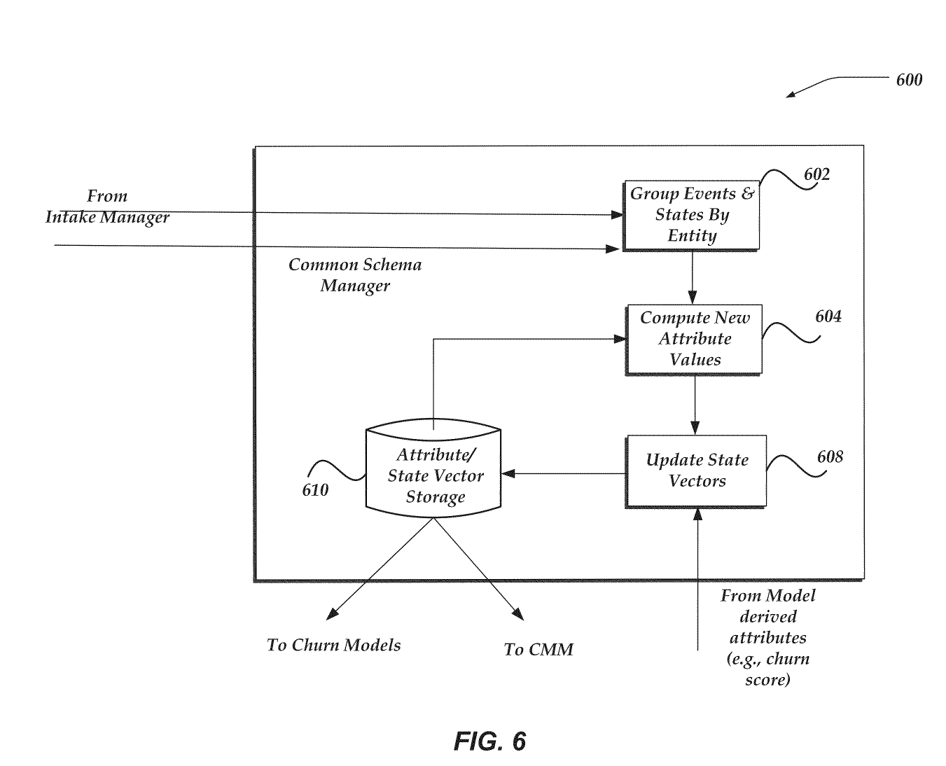

The various components of CMP 357 are described further below. Briefly, however, CMP 357 is configured to receive customer data from NSP data stores 402. CMP 357 may then employ intake manager 500 to parse and/or store the incoming data. One embodiment of intake manager 500 is described in more detail below in conjunction with FIG. 5. The data may then be provided to common schema manager 600, which may compute various additional attributes, manage updates to state vectors for entities (customer/users) within the system, and to further map raw data into a common schema. One embodiment of common schema manager 600 is described in more detail below in conjunction with FIG. 6.

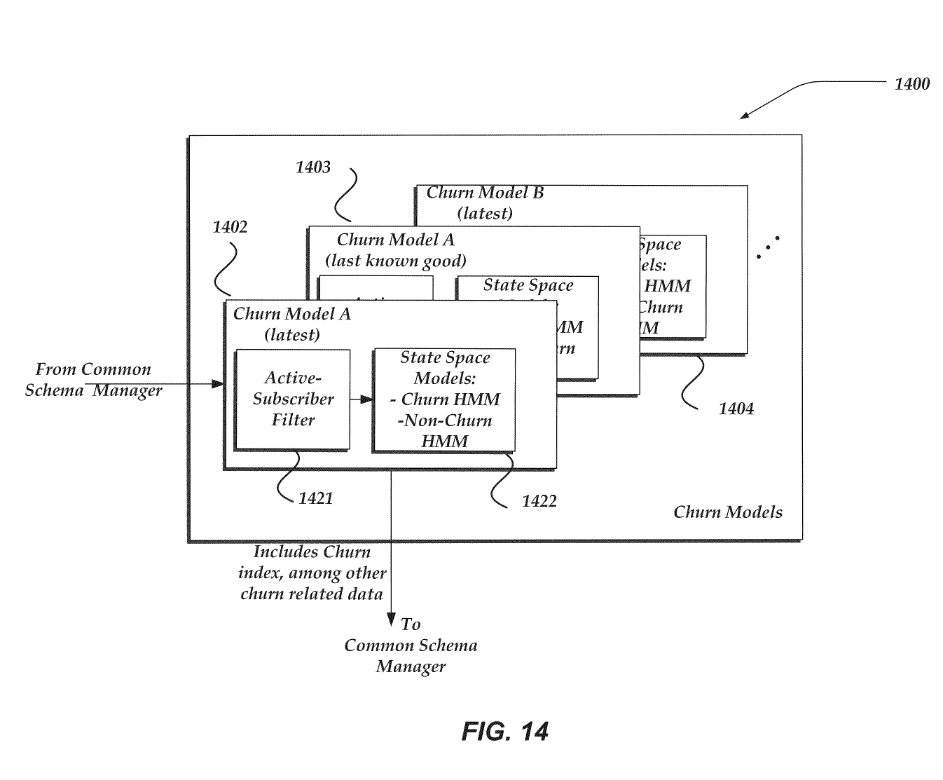

The common schema data may then be used to support a number of models, including Churn Models 1400. Briefly, Churn Models 1400, which are described in more detail below in conjunction with FIG. 14, are configured to generate subscriber churn scores and indices that are then provided to common schema manager 500 to become part of the common schema data.

Updated state vectors and the churn indices are provided to Contextual Marketing Manager (CMM) 700, which is described in more detail below in conjunction with FIG. 7. Briefly, however, in some instances, CMM 700 employs a machine learning ranking model that ranks eligible treatments based in part on randomly selecting expected/predicted feature measure in conjunction with the churn indices. The ordered ranking for each subscriber is then used to make marketing decisions. Offers may be selectively prepared into a message that is configured to reach a subscriber, who may persist or change his behavior, which is reflected in subsequent usage data.

In other instances, CMM 700 employs the churn indices to identify customers that that may be eligible for offers that are configured to attempt to minimize churn, as described in more detail below. Thus, CMM 700 may be configured to perform a variety of different actions.

In some instances it is also possible to provide the raw data directly to models, for example, to the Churn Models 1400 or the CMM 700. This may be desirable when provider specific data that is not captured by the common schema nevertheless proves to be of high value for Churn Models 1400 or CMM 700 or is otherwise useful in the operation of CMP 357.

It should be noted that the components shown in CMP 357 of FIG. 4 are configured to execute as multiple asynchronous and independent processes, coordinated through an interchange of data at various points within the process. As such, it should be understood that managers 500, 600, 700, and 1400 may operate within separate network devices, such as multiple network devices 300, within the same network device within separate CPUs, within a cluster computing architecture, a master/slave architecture, or the like. In at least one embodiment, the selected computing architecture may be specially configured to optimize a performance of the manager executing within it. Moreover, it should be noted that while managers 500, 600, 700, and 1400 are described as processes, one or more of the sub-processes within any of the managers 500, 600, 700, or 1400 may be fully implemented within hardware, or executed within an application-specific integrated circuit (ASIC), that is, an integrated circuit that is customized for a particular task.

FIGS. 5-7 and 14 illustrate various embodiments of components described above briefly within FIG. 4. It should be noted that these components of FIG. 4 may include many more or less components than those shown in FIGS. 5-7 and 14. The components shown in FIGS. 5-7 and 14, however, are sufficient to disclose illustrative embodiments for practicing the subject innovations.

FIG. 5 shows one embodiment of an intake manager (IM) 500 usable within the CMP 357 of FIG. 4. It should be noted that IM 500 may include many more or less components than those shown in the figure. However, those shown are sufficient to disclose illustrative embodiments for practicing the subject innovations. Briefly, IM 500 provides a framework for accessing raw or model produced data files that may include transactional and/or behavioral data for various entities, including customers/users of a telecommunications service provider. Events may be produced by the model, for example, control decisions (that is, the decision to not send a message to a targeted entity, but instead to hold that entity out as part of an experimental control group). These model produced events may be stored for later retrieval and in some instances may not include data shared with a provider, and therefore would not be available from a provider's data feeds.

IM 500 may receive data as described above in conjunction with FIG. 4 or from a model source, for example, certain marketing decisions produced by CMM 700. IM 500 may then employ a sub-process 502 to parse incoming data to identify event instances, locate new files, and perform any copying of the files into various storage locations and registries, such as event storage 506. Parsing may include, among other actions, matching one or more events from a given file to one or more entities, extracting particular event types, event instances, or the like. Any data translations or registrations may also be performed upon the incoming data at sub-process 502.

The data is then provided to sub-process 504, where various event instances may be identified and mapped to common events. For example, in one embodiment, a telecommunications service provider may identify events, or other types of data using a particular provider's centric terminology, form, format, or the like. Sub-process 504 may examine the incoming event instances, and so forth, to generate common events with common terminology, form, formats, and so forth, to be provider agnostic.

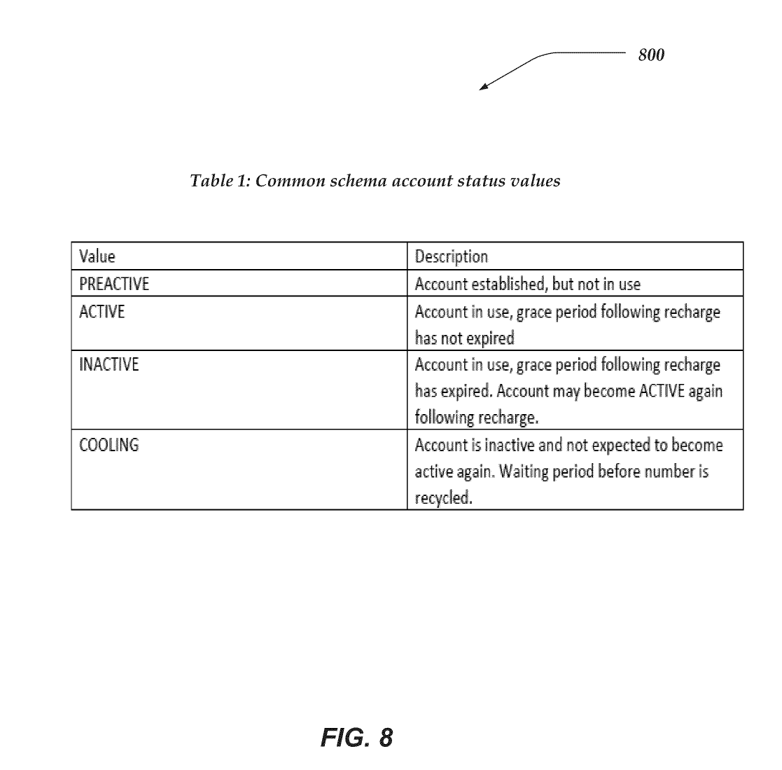

To give one non-limiting example of how data may be mapped from a carrier's schema to the common schema, consider a carrier's reported account status. In a pre-paid market, a subscriber may have an active account in addition to a positive account balance to make calls. Typically, after a subscriber recharges, a grace period is established during which the account is active and after which it reverts to inactive. Each carrier might establish its own rules to determine a status of an account. As noted common schema manger 600 maps the carrier reported values to one of several common schema values. Jumping briefly to FIGS. 8-11, Table 1 of FIG. 8 illustrates one non-limiting, non-exhaustive example of one such mapping, where the common schema values include four possible values. Carrier specific values from raw data, or values derived from carrier provided rules that match the description in column 2 of Table 1 of FIG. 8 are mapped to the common schema value provided in column 1. Non-limiting example rules might include “inactive if no recharge in the last 30 days”, as some carriers may provide an “activity status” feed while others just provide the dependent data and a set of rules to determine “activity status.” Other values may also be used. Therefore, those shown are not to be construed as restrictive of embodiments of the subject innovations.

It is common for carriers to have many more status values than these basic four. For example, the INACTIVE state of Table 1 of FIG. 8 might be broken into many distinct levels. One carrier, for example, might report 8 distinct status values that are mapped to the four in the common schema. Also, the rules for renewing the grace period (how and for how long) and the duration of other states also may vary from carrier to carrier. Again, Table 1 is intended to be illustrative of one of many possible configurations, and therefore in not to be seen as limiting.

The results of sub-process 504 may also be provided to event storage 506. As an aside, the data stores for IM 500 may be local stores (not shown) or data stores such as those described in conjunction with FIG. 3. The output of IM 500 may also be provided to various models such as the CMM 700 of FIG. 7 or the churn models of FIG. 14, as well as to common schema manager 600 of FIG. 6.

FIG. 6 shows one embodiment of Common Schema Manager (CSM) 600 usable within the CMP of FIG. 4. It should be noted that CSM 600 may include many more or less components than those shown in the figure. However, those shown are sufficient to disclose illustrative embodiments for practicing the subject innovations.

It is noted that while many attributes of an entity (customer/user) may be directly obtained from the raw data or as a result of actions performed within IM 500, there are some attributes that may also be computed or otherwise derived. CSM 600 therefore is arranged to, in part, also compute attributes for entities. CSM 600 may also update computations given current state data, or the like, to compute a new state. CSM 600 may also support the ability to include aggregate values into computations, as well as compute recursive data, convert some types of data into other formats for use within subsequent computations, or the like.

As shown in FIG. 6, CSM 600 receives data from IM 500 at sub-process 602, wherein the received data may be grouped by entity. Thus, events, state data, and so forth may be organized by entity in one embodiment. The results may flow to sub-process 604 where derived attributes may be computed and provided to sub-process 608 to store and/or update state vectors for entities in attribute/state vector storage 610.

Briefly, sub-process 604 may compute a variety of attributes, including, but not limited to recursive independent attributes, attributes having complex forms, attributes that may be computed from data provided by predictive models, user clusters, including recharge (of a mobile device) time series clusters, usage histogram clusters, cluster scoring, or the like. Computed attributes may also include values constituting of a category, cyclical values, or the like. In any event, the computed attributes may then be used to update state vectors for an entity, message, or the like, which may be performed by sub-process 604. The updated state vectors may then be extracted by sub-process 604 from the data stores, and provided to sub-process 608.

While shown within CSM 600, attribute/state vector storage 610 may actually reside in another location external to CSM 600. However, attribute/state vector storage 610 is illustrated here merely to show that data may be used and/or provided by different sub-processes of CSM 600. For example, among other things, event storage 506 and/or state vector storage 610 may provide various event data requirements used to provide data for initialization of an attribute or to derive attributes that might be computed, for example, from ‘scratch’, or the like. Attribute/state vector storage 610 may also store and thereby provide attribute dependency data, indicating, for example, whether an attribute is dependent upon another attribute, whether a current dependency state is passed to attributes at a computation time, whether dependencies dictate a computation order, or the like.

It is noted that storage of state vector data at sub-process 608 may also include storing current state data that is used in marketing, as well as historical state data for a given entity. Output of CSM 600 may flow, among other places to CMM 700 and Churn Models 1400 of FIG. 4, and conversely, those components may provide updated attribute information to sub-process 608 in order that it may be added to attribute/state vector storage 610.

As noted, Churn Models 1400 primarily (although not exclusively) receives data after it has been mapped to the common schema. By using the common schema data, churn models 1400 can easily be applied to different carriers without the need to reconfigure it to match a specific carrier's data format and schema. The data available in the event storage 506 or attribute/state vector storage 610 contains a wide range of information about individual accounts (e.g., a date an account was established) and usage events associated with that account (e.g., call time and duration or balance recharges).

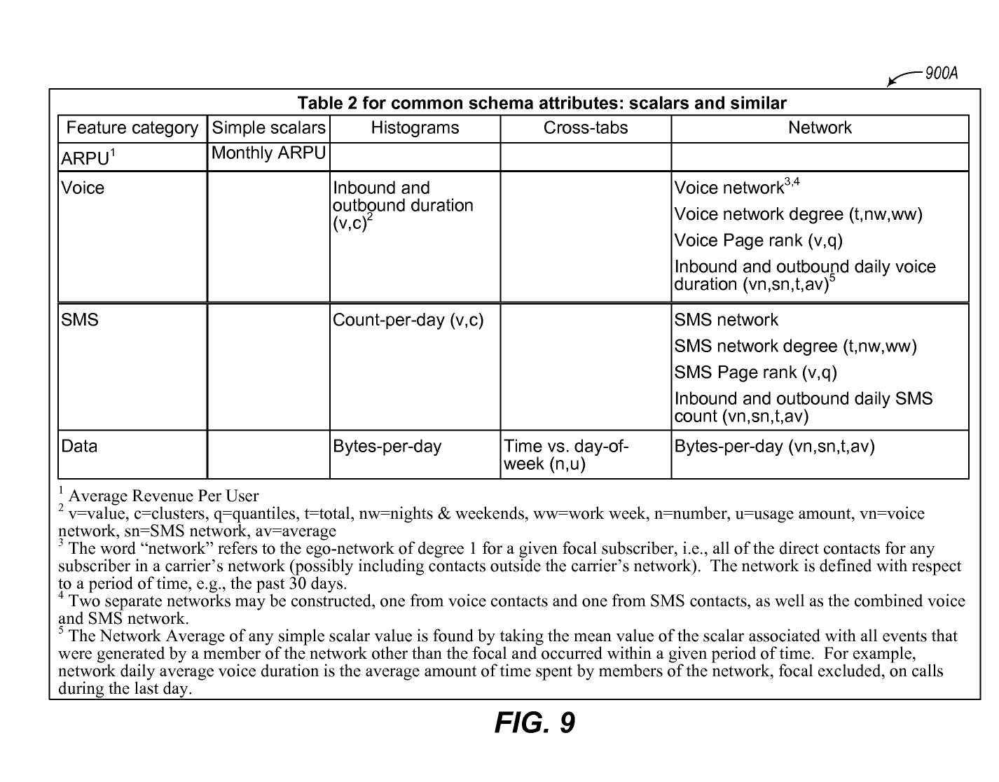

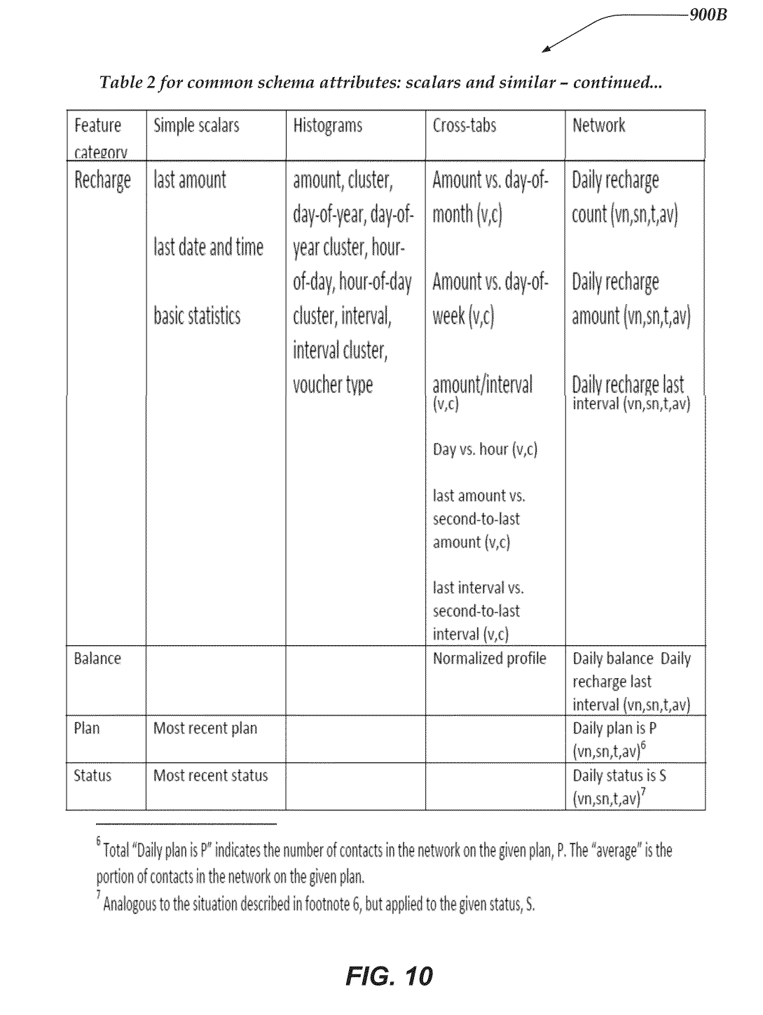

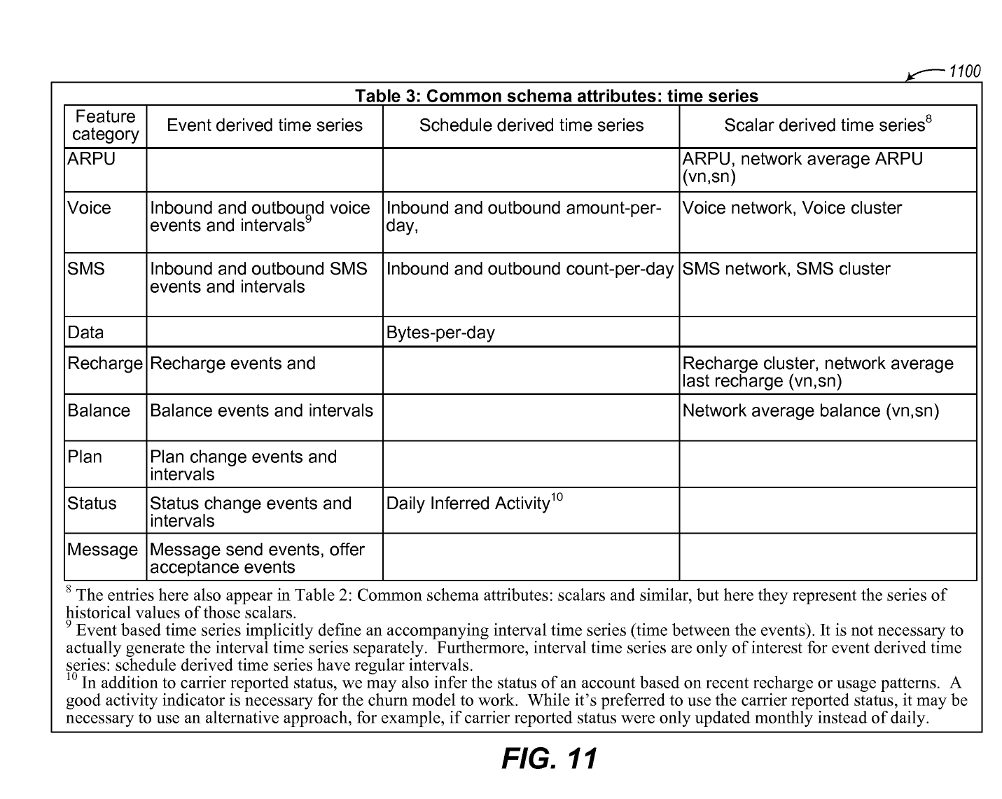

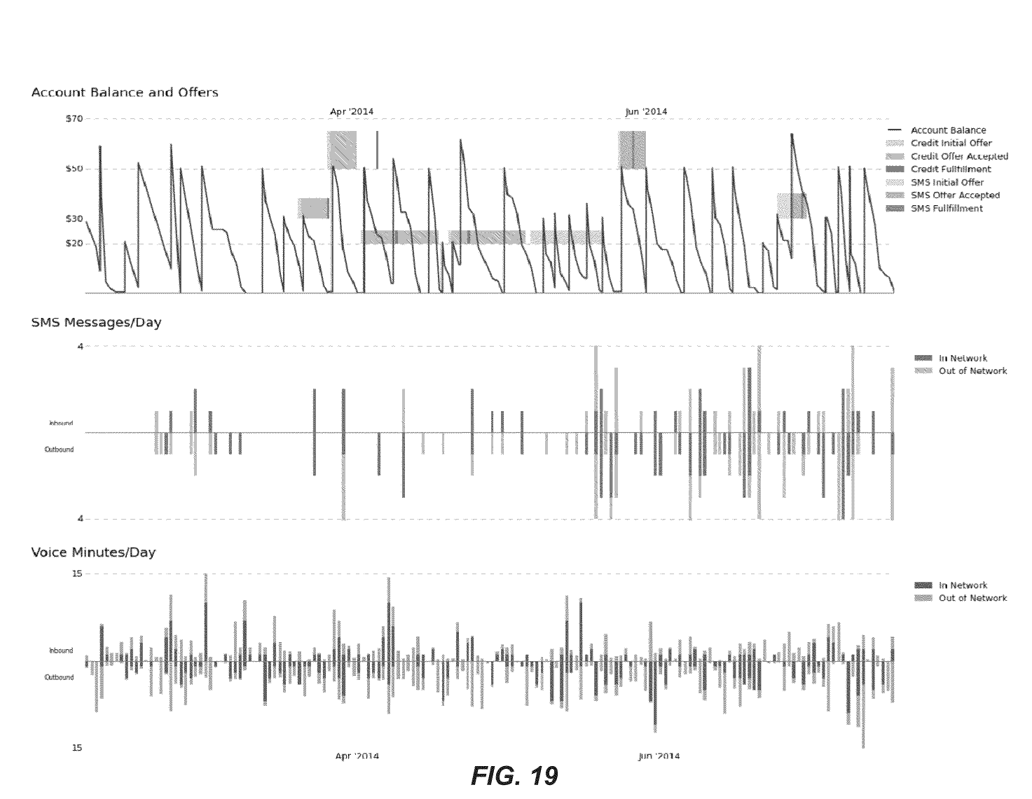

Table 2, which is illustrated in FIGS. 9-10, is shown in two parts —900A and 900B, for convenience. Briefly, Table 2 illustrates one non-limiting, non-exhaustive example of possible common schema attributes that may be used to construct the churn models disclosed further below. Again, it should be understood that Table 2 is merely illustrative and is not construed as limiting. Other attributes may be used in addition, and/or instead. As shown however, the attributes in Table 2 represent scalar and similar types of attributes. Table 3, shown in FIG. 11 illustrates other non-limiting, non-exhaustive example of common schema attributes, which are of a time series type. Some common time series data from a generic data source is depicted in FIG. 19 to further illustrate this type of data. Included are depictions of account balance, SMS, and voice activity. The data is plotted on three axes for clarity. The horizontal axis is common to all parts and represents time, while vertical axes depict daily account balance, SMS, and voice activity. As noted with Table 2, Table 3 is not to be construed as limiting the subject innovations.

FIG. 7 shows one embodiment of the contextual marketing manager (CMM) 700 usable within the CMP of FIG. 4. As shown, CMM 700 of FIG. 7 is configured to perform adaptive analysis to identify treatments for which a customer may be eligible to receive (at sub-process 702). It is noted that CMM 700 may include many more or less components than shown in FIG. 7; however, those shown are sufficient to disclose illustrative embodiments for practicing the subject innovations.

In one embodiment, sub-process 702 receives and employs data from the Attribute/State Vector data storage that further includes churn model data (described further below), including a churn index for each active subscriber. In one configuration, the result of sub-process 702 is then a rank ordered list of possible treatments that a subscriber may be eligible to receive. In one embodiment, sub-process 702 rank orders treatments, based on a predictive impact of each treatment that uses at least in part the churn index, with the objective of increasing long-term revenue for the provider. Decider sub-process 704 within CMM 700 then employs the rank ordered treatments for each subscriber in conjunction with a set of experimental constraints and marketing events to ensure that an adaptive experimental design is maintained. The output of the decider process includes a validated assignment of each subscriber to a control group, target group, or no group for each treatment, which is then used by sub-process 706 to update various decision attributes, and by sub-process 708 to compose and send various messages to a subset of customers. Thus, the churn index can be used to rank the predicted effectiveness of various messages and to define eligibility requirements that may be used by CMM 700 to direct marketing campaigns or that match appropriate offers, incentives, and messages to selected groups.

However, in another configuration, CMM 700 employs each active subscriber's churn index to identify how likely a subscriber is at risk of churning. In such activities, sub-processes 702 and 704 are then directed towards making marketing decisions about who should receive what offers and when should those offers be received to minimize churn among the entire user base.

### Churn Models

One embodiment of a Churn Model disclosed herein is a dynamic state-space model realized within the Hidden Markov Model (HMM) framework. An HMM is a model for producing sequences with certain statistical properties. The basis for this embodiment of the churn model is to produce a pair of HMMs, one that produces sequences typical of churners and one that does so for non-churners. To determine if a subscriber is a churn risk, a behavioral sequence is constructed for that subscriber and evaluated with respect to both HMMs to determine which is a more likely generator of the sequence.

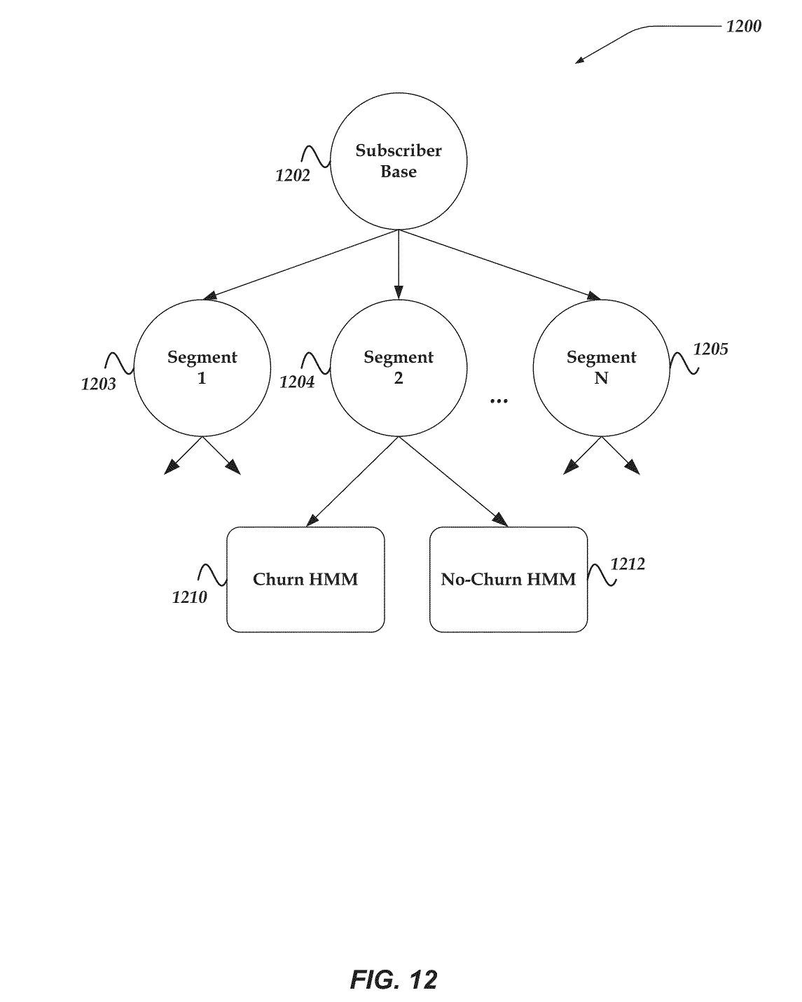

One embodiment may include more than one HMM pair) because churn/no-churn pairs are trained for different disjoint segments of the overall population as shown in FIG. 12. FIG. 12 illustrates one example of a churn model hierarchy derived from a segment 1204 that in turn is selected from subscriber base 1202. As shown, churn HMM 1210 model and no-churn HMM 1212 model may be generated for segment 1204. It is noted that similar churn models may also be generated for any or all other segments, that is, 1203, 1205, and others that have been omitted from FIG. 12 for clarity. Moreover, segment definitions take the form of criteria on subscribers, e.g., a tenure range, rather than a static list of subscribers since the user base itself is dynamic: subscribers join or leave a segment simply due the creation of new accounts and the termination of existing accounts with a carrier.

Further, there may be multiple variants of the churn/no-churn pairs for any given segment of the subscriber base because the churn models may be highly parameterized, for example, allowing for multiple definitions of churn. In such cases, a subscriber would receive multiple churn scores, one from each variant. Moreover, it can be useful to run multiple variants of the churn models in production because there are multiple uses for its output, including, but not limited to automated decisioning, churn model performance monitoring, marketing campaign configuration, marketing performance monitoring and reporting, or the like.

In any event, the churn model hierarchy may be used to track individual churn/no-churn HMM pairs for multiple segments of the total subscriber base for a telecommunications provider. Segmentation (also known as partitioning, since it would typically be complete and disjoint) may be achieved by unsupervised learning methods (e.g., k-means clustering) by using static (or slowly changing) contextual data (e.g., demographic information) or behavioral data (i.e., data akin to, but perhaps distinct from the data used to build HMMs), or any of a variety of other mechanisms. A single instance of “the churn model” may actually be an instance of the churn model hierarchy and include segment definitions and associated churn/no-churn HMM pairs. This hierarchical instance of the churn model produces a single churn score for each subscriber since the subscriber's segment assignment uniquely determines the HMM pair that produces the score.

Multiple churn models may also be configured for application to subscribers in a single segment by introducing variants of parameter settings. This allows, for example, short-term and long-term churn risk to be assessed separately. In this instance, multiple variants of the model may produce separate churn scores for each subscriber (one per variant).

Further, the churn models may be used to track individual churn/no-churn HMM pairs for multiple versions of the same (or nearly the same) segment and parameter settings. Thus, in one embodiment previous versions of a churn model may be maintained to ensure a smooth rollout and enable a rollback when necessary. In this instance, multiple variants of the model may produce separate churn scores for each subscriber (one per variant).

The set of all churn models (individual, hierarchical, variants, and versions) is depicted in FIG. 14, discussed in detail below.

### Defining Churn

Each carrier typically has an internal definition of churn, and there may be differences between carriers' definitions. Generally, however, churn indicates any subscriber who has completely stopped using the service and is unlikely to return: a subscriber lost. The subject innovations herein then are directed towards predicting whether a subscriber is likely to churn, but, has not yet stopped using the product or service. As discussed herein, it has little value to produce a churn determination after the subscriber reaches the point of no return: therefore, the models disclosed herein are directed to market to this subscriber prior to his stopping use of the carrier's product or service and hopefully retain the subscriber. Thus, the definition of churn employed herein may be a weaker one than some carriers' (in the sense that it is a more general definition that might typically be used by a carrier). Instead, churn is defined as a long-term reduction in activity. The specific definition of what constitutes “long term” and “reduction” may vary between carriers, reflecting the carriers' own policies, since these have direct impact on subscriber behavior and decision making.

To determine whether activity has decreased, a subscriber's activity level is computed during a window preceding a given date and again for a window after the date. If the activity level in the first period meets certain criteria (e.g., exceeds a certain threshold or contains a distinguishing event such as a large recharge) it is determined that the subscriber was recently active, and if the activity level in the second period meets other criteria (e.g., is below another threshold or contains a distinguishing event such as porting the phone number out of the carrier's network) it is determined that activity has dropped off and the subscriber is said to have churned.

### Behavioral Sequence

The disclosed churn models are based on a sequence of actions undertaken by a subscriber. In one embodiment, the sequence includes daily measurements of subscriber actions over a prescribed time window. The subscriber actions are defined by a select set of attributes either drawn directly from the common schema or values derived from basics measurements in the common schema. The data is represented on a daily basis, in one embodiment, to provide a high resolution for which the full range of carrier reported data is typically available. However, higher resolution (e.g. every 5 minutes) or lower resolution (e.g., weekly) representations could also be used (though in the limit significant coarsening reduces the state-space modeling approach to one equivalent to standard techniques).

### Activity Levels

An activity level is a measurement of a subscriber's use of a carrier's product and/or service. Many different data sources and methods might be used to compute the activity level. Some of the methods available for use are described below.

Some of the activity measures may be based on a carrier's reported status. However, it is noted that at least some carriers' reported statuses lag significantly behind the moment that a subscriber actually reduces activity. Even in these cases where the carrier's reported status is delayed, the churn model can employ alternative low-latency data.

### Activity Level Definition 1: Threshold on Time-Averaged Carrier Reported Status

As used herein, this activity level is defined as a percentage of days a subscriber is in the ACTIVE state during a given historical window. For example, to be considered an active subscriber a subscriber might need ACTIVE status for 80% of the days during the previous six weeks. It should be noted, however, that other values may also be used. Thus, the length of the window and value of the threshold may be adjusted between carriers.

### Activity Level Definition 2: Decreasing Trend in Time-Averaged Carrier Reported Status

This activity level is defined as a rate (or appropriate proxy) at which a carrier reported status changes during a given historical window. An active subscriber then is one for whom this rate exceeds a threshold. For example, suppose a subscriber was 50% active for three weeks, then 100% active for three weeks. The rate of activity is increasing and the subscriber would be considered active. Thus, compare to Activity level definition 1, for which the subscriber would be below the 80% level over the six-week window, thus inactive.

It is noted that this definition is not equivalent to a new threshold of 75% for six weeks, because the order of events is also relevant: first low activity, then high. The same values in this example, but in reverse order might then indicate a decreasing activity and a potentially inactive subscriber.

### Activity Level Definition 3: Threshold on Time-Averaged Account and Usage Data

This activity level is defined as the percentage of days a subscriber meets certain account or service usage goals during a given historical window. For example, to be considered an active subscriber, a subscriber would have recharged the account on 10% of the days in the window and used voice service on a mobile device during 90% of the days in the same window. Any combination of common schema attributes might be selected, and the length of the window can be adjusted on a per-carrier basis. Also, rather than a percentage of days a service was used, a usage amount threshold might be set (e.g., a total of 20 or more SMS messages during the entire window).

### Activity Level Definition 4: Clustering on Low-Pass Wavelet Filtered Carrier Reported Status

Clustering based on low-frequency wavelet coefficients produces results of similar quality to the threshold approach in definition 1, but enjoys the advantage of effective automatic threshold detection. This may be termed “effective” because it is not necessary to determine, express, store or otherwise employ an actual threshold in this approach. However, the results have been largely consistent with the threshold approach of definition 1. That is, it produces nearly the same results as the threshold approach for a certain threshold level. The advantage to this approach is that it is not necessary to discover the threshold. It is implicitly revealed by this approach.

A time series of carrier reported status may be a piecewise constant function since status can, in some embodiments, change at most daily, and may take on one of a few finite values. Furthermore, it changes infrequently when represented as a daily value. In one embodiment, it can therefore be exactly represented with Haar wavelets. First, the wavelet transform is performed on the daily time series of carrier reported status. High frequency components are set to zero (i.e., a low-pass filter is applied). Since, in one embodiment, it may be desirable to cluster time series based on low frequency components, the inverse transform need not be applied.

The handful of remaining wavelet coefficients may be used to represent the sequence and k-means clustering may be applied to the sequences from a representative set of subscribers. In some embodiments, there may be four qualitatively distinct clusters of subscribers that might be qualitatively (or informally) described as: always active, partially active, always inactive, and phasing out. Setting the number of centroids to values greater than four tends to refine groups within these clusters, but might not produce qualitatively new clusters.

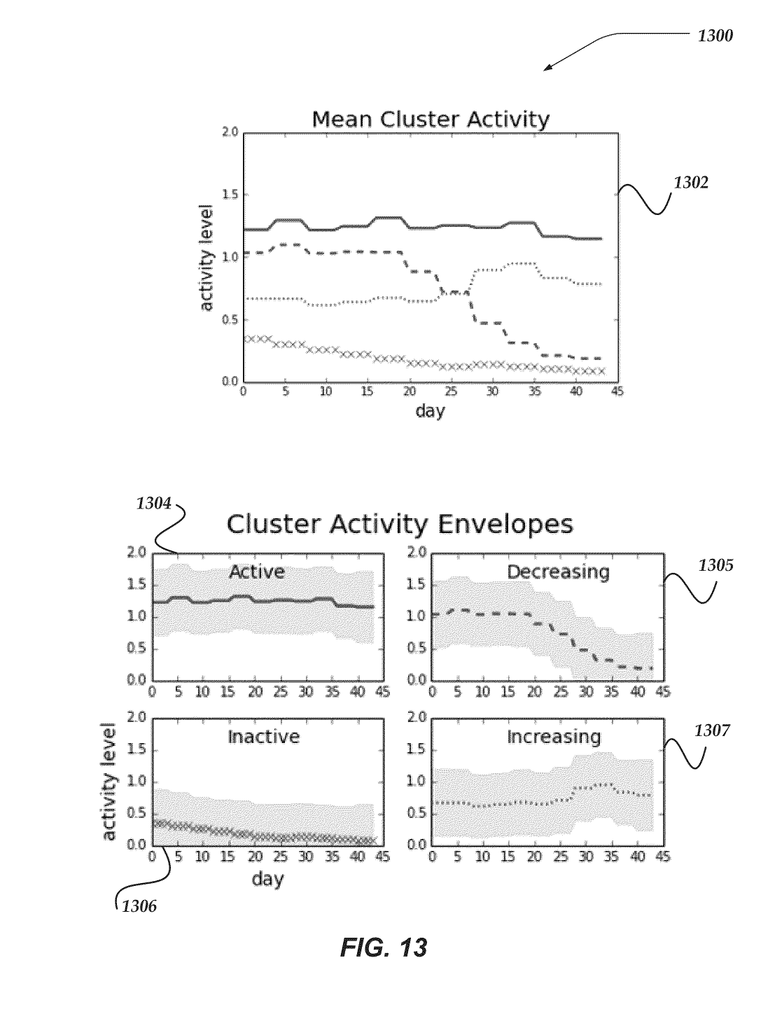

One non-limiting non-exhaustive example of possible behaviors from three of the clusters is shown in FIG. 13. The horizontal axis on graphs 1302-1307 represents time in days and the vertical axis indicates activity level. In graph 1302, lines show mean activity as a function of time for members of each cluster. The solid line represents the “always active” case and the line of x's the “always inactive” case. The dashed and dotted lines show two variants of the “partially active” case, one decreasing over time, and the other increasing. No example of the “phasing out” group is shown (as it may be indicated by a prolonged zero activity level and in any case represents subscribers who have already been inactive for some time, i.e., subscribers for which a churn determination would be of little value). Graphs 1303-1307 of FIG. 13 show each of the four cases separately within an envelope indicating a variance in each population (±1 standard deviation).

On inspection, the “always active” cluster of graph 1304 is nearly identical to the active group of subscribers produced by the threshold method in definition 1 for a particular value of the threshold. However, a precise value of the threshold is selected by the person configuring the model when using definition 1, whereas the clustering approach in definition 4 makes the distinction automatically.

### Activity Level Definition 5: Rule Based Activity Definitions

The previous definitions have relied on a measure of activity exceeding a certain threshold, however, it can also be useful to employ rule based definitions that determine activity by certain events or criteria. Many carriers employ such definitions to determine the carrier reported status used in Activity level definition 1 above, for example, by defining a subscriber as active if he has recharged his account within the last several days and for a certain amount (where furthermore, the number of days depends on the amount). Other examples include marking a subscriber as inactive immediately on the event that the subscriber ports a line to another carrier, regardless of other recent activity on the account. Many other variations are also possible.

### Activity Level Definition 6: Combination of Basic Activity Levels

Still another way to determine the activity level is to combine two or more of the previous definitions. For example, to use a rate threshold in conjunction with an activity threshold: to be active, a subscriber must have a baseline activity level of 25% and a steady or increasing activity rate. Other approaches may also be employed.

FIG. 14 shows one embodiment of Churn models 1400 useable with the CMP of FIG. 4. As shown, Churn models 1400 may include a plurality of sub models 1402-1404. Each of churn models 1402-1404 may include a plurality of sub-components. Churn models 1402-1404 may include many more or less components than those shown in FIG. 14. However, the components shown are sufficient to disclose an illustrative embodiment for practicing the subject innovations.

As shown in FIG. 14, for example, churn models 1402 includes two sub components, Active-subscriber filter 1421 and state-space models 1422. Active-subscriber filter 1421 represents a filtering component to select subscribers of interest, while state-space models 1422 represents a pattern recognition component based on a state-space behavioral model. In one embodiment, state-space models 1422 may be implemented within the HMM framework. The models are trained and calibrated using historical data, as discussed further below. Once ready, state-space models 1422 are deployed to a production system. As baseline subscriber behavior evolves, state-space models 1422 may be retrained. In some embodiments, the retraining may be based on monitoring the performance of the production system, for example, the accuracy of the predictions. However, retraining may be based on other criteria, including a schedule, detected changes in the baseline subscriber behavior, or any of a variety or combination of other criteria.

### Active-Subscriber Filter

As shown in FIG. 14, in one embodiment, the churn model is only applied to active subscribers. It is unnecessary to apply the model to subscribers who do not have any recent account activity. Furthermore, if inactive subscribers were retained during model training, the expected quality of the model would decrease. In any event, adding a significant number of low-information data to the training set would unnecessarily increase the computational expense (measured in either time or computational resources) necessary to train the model.

Thus, as employed active-subscriber filter 1421 is applied, based on the activity level definitions. A typical example is to use Activity level definition 1: Threshold on time-averaged carrier reported status with the most recent four to six weeks of activity and a threshold between 70% and 90%.

The activity level is computed for subscribers with a complete behavioral sequence. If a subscriber joins or leaves the network during the interval defining the behavioral sequence, then that subscriber is excluded by the filter. In particular, this is indicated when a subscriber enters either the PREACTIVE or COOLING states at any time during the behavioral sequence interval. For example, suppose Activity level definition 1: Threshold on time-averaged carrier reported status is used with a 30-day window and an 80% threshold. If a subscriber is ACTIVE for the first 29 days, but then enters the COOLING state on day 30, that subscriber is rejected by the filter even though he meets the 80% criteria. Patterns like this one do occur (no period of inactivity before cooling) and are an indicator of active churn: for example, if the subscriber has notified the carrier and ported his number to another network.

### State-Space Model of Subscriber Behavior

Churn Models shown in FIG. 14 indicate that churn modeling is based on a state-space model of subscriber behavior, as illustrated by state-space models 1422. This is a major distinction between the disclosed approach and traditional models which represent subscriber behavior as a non-sequential set of characteristics. The distinguishing factor is that a state-space model explicitly represents the sequence of events. For example, if a subscriber only makes calls soon after recharging, a state-space model would capture this order of events, while traditional models would likely lose this information. A traditional modeling approach may only retain this information, but only through an encoding of sequential behavior in a “flat” format. Such a process requires expensive feature selection via either an ad hoc determination or an exhaustive automated approach, or, if feature selection is neglected, threatens model quality degradation due to the large number of likely encodings The state-space approach captures these important relationships by design.

When constructing a state-space model, the subscriber's state is not typically something that can be measured directly. It is not captured explicitly in a carrier's data. Instead one expects to observe the side effects of a subscriber's state, e.g., calls made or recharge activity. Subscriber state is therefore considered to be “hidden” and is deduced from a subscriber's behavior.

As mentioned elsewhere, the churn models disclosed herein are built upon the Hidden Markov Model (HMM) framework. This approach applies certain assumptions to the more general set of state-space models. In particular, an assumption made within the HMM framework is that state transitions form a Markov process, and sequences of observations represent events which are generated by a subscriber in a given state. Using the observed sequences from many subscribers one can deduce the most likely set of model parameters to have generated the observations (i.e., train the model). Once a model is identified, one may compute the likelihood that it would generate a particular observed sequence. Given separate models, one built to recognize churners and one for non-churners, it is possible to decide whether a subscriber's recent activity is more representative of one group or the other (i.e., use the model in production).

Any of a variety of mechanisms may be used to derive the HMM may be employed. For example, one such non-limiting reference is “A tutorial on Hidden Markov Models and Selected Applications in Speech Recognition,” by L. R. Rabiner, published in Proceedings of the IEEE, Vol 77, No. 2, February 1989, and which is incorporated herein by reference in its entirety. The following briefly lists relevant HMM specific material to illustrate one approach to constructing the subject innovations. Other dynamic state-space or specific HMM implementations may also be used. As such the subject innovations are not constrained to any single model. Thus, the equations provided below, are merely illustrative and not to be construed as limiting. In any event, references to equations and figures are to the Rabiner article for convenience.

### HMM Framework: HMM Basics

The following provides elements of an HMM.

The following notation is used to represent elements of an HMM:
N, the number of states
M, the number of distinct observable symbols
qₜ, the hidden state at time t
S={Sᵢ}, the discrete set of states
V={vₖ}, the discrete set of observables
A={aᵢⱼ}, state transition probability matrix. The elements of the transition probability matrix are defined in Equation (1) as:

aᵢⱼ=P[qₜ₊₁=Sⱼ|qₜ=Sᵢ], 1≦i,j≦N (1)
B={bⱼ (k)}, is the distribution of observable symbols for a given state, the elements of which are given by Equation (2):

bⱼ(k)=P[vₖ at time t|qₜ=Sⱼ], 1≦j≦N and 1≦k≦M (2)
π, the initial distribution of states, given by Equation (3),

πᵢ=P[q₁=Sᵢ], 1≦i≦N (3)
λ, the complete set of parameters specifying a particular HMM, alternatively referred to as “a model”. It consists of A, B, and π as defined above.

To employ the churn model, it is necessary to carry out the following basic tasks for each HMM:

1. Given an observed sequence and a fully specified HMM, compute the likelihood of the sequence under the HMM. In the disclosed subject innovations, this is an essential part of producing a prediction in the production system discussed below.

2. Given a set of observed sequences, find model parameters that maximize the likelihood of the observations. The model training discussed below employs this approach to fully specify each HMM.

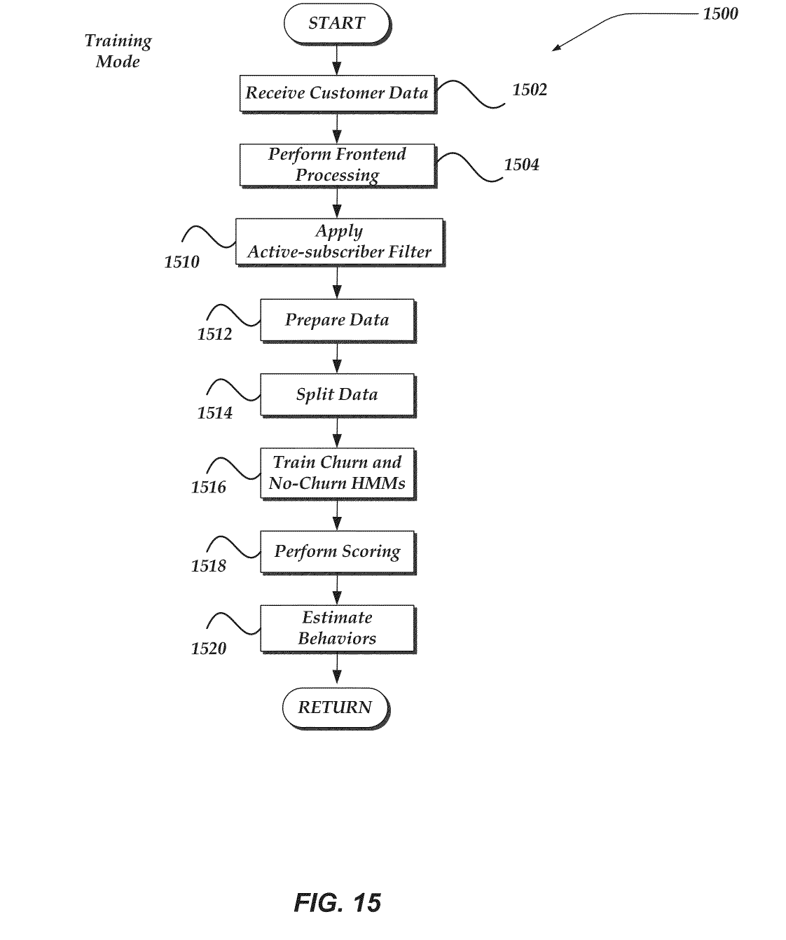

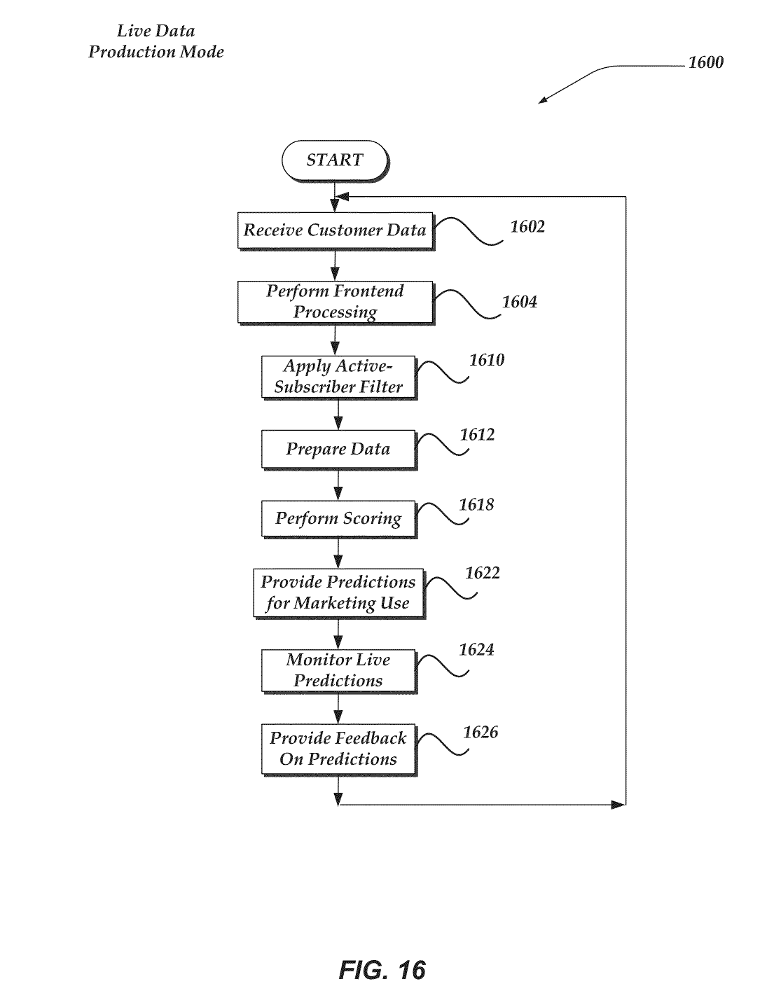

The operation of certain aspects of the Churn Models of FIG. 14 may be described with respect to FIGS. 15-16. FIG. 15 shows one embodiment of a process flow useable to train Churn and No-Churn Hidden Markov Models (HMM). Process 1500 of FIG. 15 may be implemented within any one or more of the Churn Models 1402-1404 of FIG. 14, which in turn operates within CMP 357 of FIG. 4.

Process 1500 of FIG. 15, begins after a start block, at block 1502, where customer/subscriber data is received. The subscriber data may be extracted from a representative set of a service provider's data set. In one embodiment, the received data is raw data from the service provider's data set (though data may also be received from other sources, e.g., provider supplied behavioral data might be augmented with publicly available social media postings). Processing then moves to block 1504, where various frontend processing may be performed on the data, including those actions discussed above in conjunction with FIGS. 5-6, where the raw data may be parsed, and mapped to a common schema. Frontend processing may also include mapping subscribers to subscriber base segments if subscriber base has been partitioned as described in conjunction with the description of FIG. 12.

Before actually performing training with the data (or later performing the operational process of FIG. 16), a number of data preparation steps are performed. The same data preparation steps (including active subscriber filtering) are carried out for both model training and use of the model in operation, as discussed below in conjunction with FIG. 16.

Data preparation includes 1) selecting active subscribers with the active-subscriber filter, 2) constructing sequences of behavioral observations for the active subscribers, and 3) determining a churn label for model training and (once enough time passes for it to become available) operational model performance monitoring. For model training and calibration, the prepared data is split into independent sets for training, testing, and validation. Furthermore, the training and test sets may actually be a single train/test set for use with a cross-validation approach to model determination. Cross-validation is a process in which separate train and test sets are repeatedly chosen at random from a joint train/test set and many candidate models trained to provide information on (and furthermore reduce) the bias induced by a particular choice of training and test sets.

In any event, process 1500 flows next to apply the active-subscriber filter, at block 1510. That is, given a time window, the filter identifies all subscribers who meet the chosen definition of active, based on one of the methods detailed above for determining Activity Levels.

For model training, the dates are not only in the past, but are far enough in the past so that a historical record of the “future” section is available, that is, a time window following the active-subscriber window during which low activity subscribers are determined to have churned. This enables knowing of the churn/no-churn outcomes for individuals at the time of training.

Processing then proceeds to block 1512, where further data preparation actions are performed including constructing behavioral sequences. At block 1512, daily time series of subscriber behavior are constructed from common schema attributes. Several considerations are made while constructing the sequences. One such consideration includes selecting the features of interest. To improve model quality and robustness (in part by balancing the amount of available training data and model complexity, and in part by relying mainly on data expected to be available from a wide range of carriers) only a few select common schema attributes are used. To determine which features to use, many potential models are constructed and tested. The best performing models, and the features associated with them, are selected. The determination of “best” does not imply simply selecting the features which appear in the single highest performing candidate, but in selecting features common to several of the highest performing models. That is, features are selected for both absolute performance and robustness. Methods for measuring model quality are listed below.

### Aggregation

Depending on the feature in question, it may be desirable to aggregate several discrete events in order to map the data to a daily sequence used by the model. For example, a time series of individual call duration events might be transformed into a daily variable by summing all of the call durations that occur to produce a daily total duration for each day in the sequence of days in question. Variables may also be aggregated by count as well as amount (e.g., the number of calls in a day vs. the total time on the phone in a day).

If there is no activity on a given day one of two actions is typical. For usage attributes, such as call duration or recharge amount, the daily aggregate value may be set to zero. For status change attributes, such as the carrier reported status update time series, the value of the attribute persists between events on the time series: if a subscriber became ACTIVE Monday and switched in INACTIVE on Friday, then the value for the subscriber on Wednesday would be ACTIVE even though no data is reported on Wednesday in the common schema (that is, “no data” implies “no change”).

### Derived Features

Some features may be derived from the common schema data. The most prominent of these includes a feature that measures total revenue-generating activity. Revenue-generating activity represents the sum total of all revenue-generating actions taken by a subscriber. A precise definition may vary between carriers according to their various plan details, but typically this consists of outbound calls and SMS, as well as all data usage. There may be additional revenue-generating actions as well (e.g., purchase of a ring-tone). In order to add activities of different types, in particular calls to SMS to data (and so on), each type of action is measured by the amount of revenue it generates (e.g., the actual dollar amounts associated with each action).

Another derived feature might include an approximate revenue-generating activity. That is, it can also be effective to use approximate dollar amounts rather than precise dollar amounts. For example, an artificial unit is established in which 10 SMS=1 minute call=10 kb data.

### Typical Features

The following provides a non-limiting, non-exhaustive list of typical features that may be of interest for use within the churn models:
Carrier reported status
Recharge activity
Revenue-generating activity (exact or approximate)
Social network attributes—in one embodiment, derived from Call Data Records for Voice and SMS interactions
   Examples are the size of an ego network or individual subscriber attributes averaged over the ego network (e.g., average ARPU, average activity level, average, revenue-generating activity).
   When computing values over the ego network it is necessary to identify and filter out automated numbers (e.g., call centers, 800 numbers). These are either directly identified form a list of known numbers, or discovered through network analysis (for example, such numbers often connect to hundreds of thousands or millions of subscribers, far more than an individual could physically contact).

### Discretization (Vector Quantization)

Many common schema attributes can take on a continuum of values, e.g., the daily duration of voice calls. The churn model, in one embodiment, is based on a discrete HMM in which the observed values in the daily sequence are assumed to come from a discrete set. Therefore, continuous features may be discretized in order to use a discrete HMM (other embodiments may be based on continuous HMMs).

In many cases continuous variables are mapped to one of two bins: zero or non-zero. This is used for variables related to consumption, such as call duration or daily recharge amount. It may also be applied to discrete features that can take on many values such as SMS count. This discretization scheme indicates, on a daily basis, weather a subscriber used a particular service or not.

Sometimes it is helpful to further quantify the non-zero values by adding more bins to the discretization scheme. One bin may still be reserved for zero usage (possibly including missing data or a second bin may reserved for missing data if missing data is not otherwise mapped to a standard value), and the remaining bins are determined by computing quantiles over the remaining data (after removing all the zeros). For example, if three bins are specified, one is for zero values, one is for non-zero values below the median of the remaining data, and the third is for values above the median. This characterizes subscriber usage as zero, low, or high. The determination of the best discretization scheme is part of the feature selection process described above and will in part depend on the size of the training set (robust results from a smaller data set requires a simpler model and thus fewer bins).

To determine quantiles over non-zero data one of two different approaches may be used: individual normalization and group normalization. For individual normalization, the quantiles are computed on an individual subscriber basis. Suppose the three-bin scheme described above is used. By normalizing on an individual basis, high activity means high for the individual; a fixed amount may map to high activity for one subscriber and low activity for another. On the other hand, when group normalization is used, the quantiles are computed across the population; high activity is high activity across all subscribers. Individual normalization may be used alongside group normalization when interested in creating a sequence that is representative of an individual's behavior: a high spender who slashes overall spending is potentially a greater churn risk than a low, but steady spender.

### Handling Missing Data

It is necessary to handle cases in which data that should be available is missing. So far, missing data has not been described: data exists in the cases covered so far, but perhaps in a form that makes it appear missing when it needs to be accessed. For example, it is standard to only record attribute values when the value changes, thus, for a given subscriber on a given day, there may be no record of a specific attribute. To address the absent data, one may interpolate values to create a daily sequence as detailed above. In another case, the absence of a value indicates that zero activity occurred (e.g., no recharges on a particular day). In both these cases the data is not actually missing. The necessary task is simply to transcribe it from one representation to another. On the other hand, values such as daily account balance (or even subscriber state if no historical status updates has been received) cannot be precisely deduced from the data that is available.

One potential cause of missing data is an interruption in the ingestion of carrier data. This type of interruption may be indicated by a broad gap in the data collected during the interruption. Suppose there is a one-day service interruption. Since the values used are discrete, one method that can be used (and is typically used as a fallback when others fail) is to introduce a new value for the variable that indicates missing (e.g., add a fourth bin to the previous example to get: missing, zero, low, and high). It may also be possible to make reasonable estimates of other values in such cases, but these are decided on a feature-by-feature basis. For example, event triggered time series data such as status updates it is possible that a status change occurred on the missing day but was not recorded (this could lead to inconsistencies in the time series such as two consecutive ACTIVE values, which should have had an INACTIVE value recorded on the missing day). However, status changes are relatively rare so it is reasonable, on balance, to carry forward the last recorded value in these cases (i.e., to assume that inconsistencies that arise due to a short service interruption are themselves short-lived and therefore have too small a performance impact to warrant further correction).

### Computing Labels

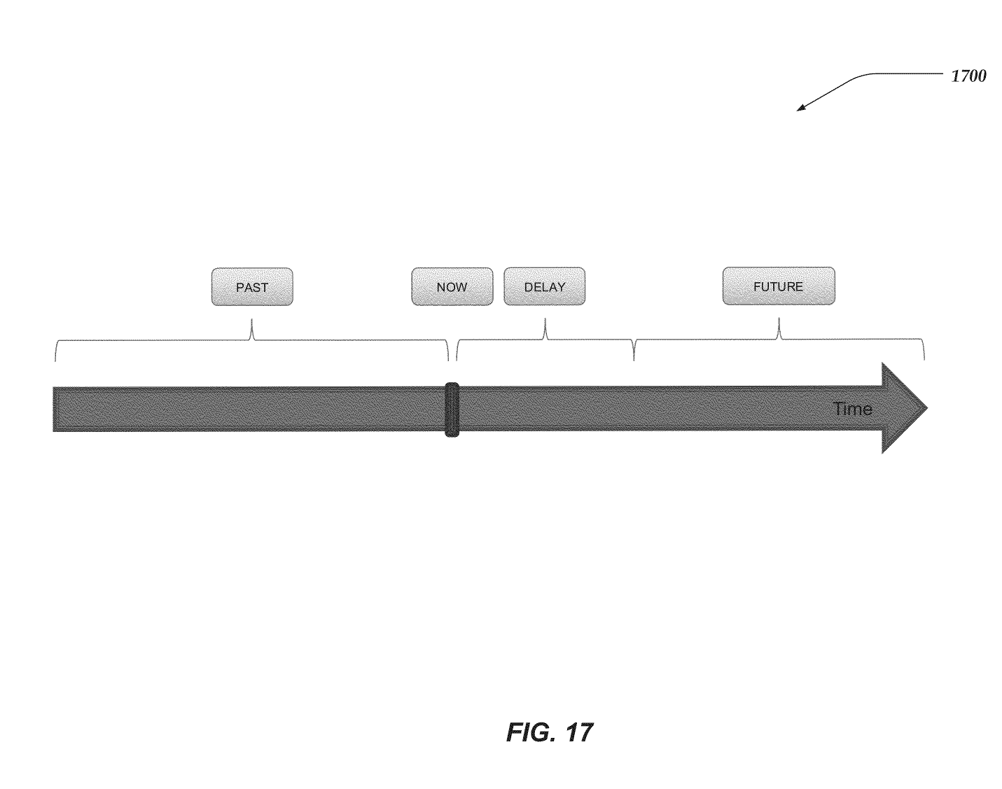

For model training and monitoring, it is desired to determine which subscribers are churners and which are not. This is possible after a sufficient amount of time has passed following the interval for which the behavioral sequence was determined as shown in FIG. 17.

The churn model is a pattern matching tool. The resulting HMM models are not used to directly compute future subscriber actions, rather, separate HMMs are computed for two groups: subscribers who later churned, and subscribers who did not. The label sequence is used to determine which subscribers belong to which group. To determine which subscribers are churners in historical data, the activity level is computed from the label sequence in similar manner as used in the active-subscriber filter (possibly different activity level definitions are used). Churners are those subscribers whose activity level meet certain criteria, for example, is below a set threshold or subscribers who enter the PREACTIVE or COOLING state during the label sequence interval. The churners then are subscribers who were previously active (they passed through the active-subscriber filter), but are no longer active.

Further Refinement by Sub-Population Targeting

While the pattern matching approach includes splitting subscribers into groups of churners and non-churners, if sufficient data is available, greater accuracy can be achieved by subdividing the general population into multiple groups. For example, different rate plans can substantially change the incentives and therefore the decision processes of subscribers. Instead of simply creating one HMM for general churners and on for general non-churners, separate HMMs can be trained for churners and non-churners associated with each individual rate plan offered by a carrier. The general procedure remains unchanged: HMMs for each group are trained, and the classification of a new behavioral sequence is determined by finding which of all of the HMMs is most likely to have produced the sequence.

In any event, upon preparing the data at block 1512, process 1500 of FIG. 15 flows next to block 1514. At block 1514, data may be split into three non-overlapping sets: train, test, and validate sets. In another embodiment, the data may be split into two non-overlapping sets: train/test and validate sets for cross-validation.

The training set contains examples of both churners and non-churners. It is not necessary that the proportion of churners to non-churners be the same in the training set as in live data. For example, the training set may consist of approximately half churners and half non-churners. Typically, at least several thousand examples from each class are necessary for training.

The test set does contain the natural proportion of churners to non-churners (typically, less than 5% are churners). The test set is used to calibrate the model. Calibration requires a tradeoff between different types of errors, chiefly false positives and false negatives. Both represent errors, but the relative cost of a false positive (incorrectly labeling a non-churner as a churner) is not generally the same as that of a false negative (incorrectly labeling a churner as a non-churner). It is important to understand not only the propensity for each type of mislabeling, but also the actual proportion of one type to the other in production (thus the natural proportion of churners to non-churners in the test set).

The validation set is used to get an unbiased estimate of model performance (since the training and test sets were used to determine model settings). It should also contain the natural proportion of churners to non-churners.

Process 1500 then flows to block 1516, where the HMM framework is employed to train the model. The training set is used to train churn and non-churn HMMs using the standard expectation maximization (EM) approach. Any of a variety of EM implementations may be used, including for example, the iterative procedure such as the Baum-Welch method, which is dependent on the Forward-Backward procedure.

In one embodiment, individual HMMs are trained using the Baum-Welch procedure. First, initial values for model parameters are chosen, potentially at random.

Next, the Forward-Backward Procedure is employed: consider the forward variable aₜ (i) defined as:

aₜ(i)=P(O₁O₂ . . . Oₜ,qₜ=Sᵢ|λ) (4)

i.e., the probability of the partial observation sequence, O₁O₂ . . . Oₜ, (through time t) and state Sᵢ at time t, given the model λ. One may then solve for aₜ (i) inductively, as follows:

### 1) Initialization:

a₁(i)=πᵢbᵢ(O₁), 1≦i≦N. (5)

### 2) Induction:

$${α}_{t + 1} ( j ) = [ {\sum }_{i = 1}^{N} {α}_{t} ( i ) {α}_{ij} ] {b}_{j} ( {O}_{t + 1} ) , \\ 1 \leq t \leq T - 1 and 1 \leq j \leq N . \qquad ( 6 )$$

### 3) Termination:

$$P ( O \vert λ ) = {\sum }_{i = 1}^{N} {α}_{T} ( i ) . \qquad ( 7 )$$

The result of Equation (7) is the likelihood of an observed sequence given a particular model, i.e., the likelihood necessary for scoring the churn and no-churn HMMs (employed later in conjunction with process 1518).

In a similar manner, consider a backward variable βₜ(i) defined as:

β_{T}(i)=P(Oₜ₊₁Oₜ₊₂ . . . O_{T}|qₜ=Sᵢ,λ) (8)

i.e., the probability of the partial observation sequence from t+1 to the end, given state Sᵢ at time t and the model, λ. Again, one can solve for βₜ (i) inductively, as follows:

### 1) Initialization:

β_{T}(i)=1, 1≦i≦N. (9)

### 2) Induction:

$${β}_{T} ( i ) = {\sum }_{j = 1}^{N} {a}_{ij} {b}_{j} ( {O}_{t + 1} ) {β}_{t + 1} ( j ) , \\ t = T - 1 , T - 2 , … , 1 , \\ 1 \leq i \leq N . \qquad ( 10 )$$

From α and β we can further deduce variables γₜ(i) and ξₜ(i,j) as follows,

$$\begin{matrix}{ξ}_{t} ( i , j ) = P ( {q}_{t} = {S}_{i} , {q}_{t + 1} = {S}_{j} \vert O , λ ) = \frac{{α}_{t} ( i ) {a}_{ij} {b}_{j} ( {O}_{t + 1} ) {β}_{t + 1} ( j )}{{\sum }_{i = 1}^{N} {\sum }_{j = 1}^{N} {α}_{t} ( i ) {a}_{ij} {b}_{j} ( {O}_{t + 1} ) {β}_{t + 1} ( j )} & ( 11 ) \\ {γ}_{t} ( i ) = {\sum }_{j = 1}^{N} {ξ}_{t} ( i , j ) & ( 12 )\end{matrix}$$

Finally, updated model parameters are produced,

$$\begin{matrix}{π}_{i} = {γ}_{1} ( i ) & ( 13 ) \\ {a}_{ij} = \frac{{\sum }_{t = 1}^{T - 1} {ξ}_{t} ( i , j )}{{\sum }_{t = 1}^{T - 1} {γ}_{t} ( i )} & ( 14 ) \\ {b}_{j} ( k ) = \frac{{\sum }_{t = 1 , such that {O}_{t} - {v}_{k}}^{T} {γ}_{t} ( j )}{{\sum }_{t = 1}^{T} {γ}_{t} ( j )} & ( 15 )\end{matrix}$$

Iteration continues until model parameters converge with respect to a desired degree of precision.

It is necessary to specify the number of hidden states in the model. During training, a large number of models are constructed and then compared to determine which have the best performance. The number of hidden states is treated as a variable and determined by those models exhibiting the best performance (where robustness also contributes to the determination of “best”).

An alternative approach to training is to use a Bayesian framework for training. While this approach is computationally expensive, it can be used to quantify model uncertainty (e.g., provide measures of confidence in a particular model).

Processing flows next in process 1500 to block 1518, where scoring and classifying of sequences for the HMM framework is performed. To test the model and use it in operation, it is necessary to have a method to score sequences given a model. Several approaches may be employed including the Forward portion of the Forward-Backward Procedure described above, which is, the output of Equation (7).

Once the likelihood that a model produced a given behavior sequence is computed, the classification task is a simple test:

1. Compute the likelihood that a behavioral sequence was produced by the churn HMM

2. Compute the likelihood that a behavioral sequence was produced by the non-churn HMM

3. Compare the two values: predict that the subscriber is a churn risk if the churn HMM likelihood is greater than the non-churn HMM likelihood plus an offset

L_{c}−L_{nc}>ε (16)

Although typically, the sequence length for the churn and non-churn HMMs is identical, it is relevant to account for sequence length when comparing likelihoods from different HMMs. Furthermore, a normalization scheme (division of the log of the likelihoods by the sequence length) may be used to account for a systematic error introduced by differences in sequence length (if any) between the churn and no-churn HMMs.

Thus, we can realize the concept of distance between models (i.e., model dis-similarity) by defining a distance measure, D(λ₁,λ₂), between two Markov models λ₁ and λ₂, as:

$$D ( {λ}_{1} , {λ}_{2} ) = \frac{1}{T} [ log P ( {0}^{( 2 )} \vert {λ}_{1} ) - log P ( {O}^{( 2 )} \vert {λ}_{2} ) ] \qquad ( 17 )$$

where O⁽²⁾=O₁O₂O₃ . . . O_{T} is a sequence of observations generated by model λ₂ [34]. Basically, equation (17) is a measure of how well model λ₁ matches observations generated by model λ₂, relative to how well model λ₂ matches observations generated by itself. A standard symmetric version of this distance is

$${D}_{S} ( {λ}_{1} , {λ}_{2} ) = \frac{D ( {λ}_{1} , {λ}_{2} ) + D ( {λ}_{2} , {λ}_{1} )}{2} . \qquad ( 18 )$$

At least one definition of model distance is necessary to carry out the classification procedure embodied by Equation (16).

Moving next in process 1500 of FIG. 15 to block 1520, the operating point is selected for model calibration and then used for estimating a behavior. The offset is a relevant parameter. If it is large (and positive) only sequences that are much more likely to have come from the churn HMM are identified as churn risks. Choosing a value for E allows one to make a tradeoff between types of classification error (false positives vs. false negatives). The value is selected during model testing: this is the calibration step and is distinct from model training (at block 1516). Choosing the value does not modify the HMMs themselves, rather, this act is to set the operating point, i.e., the threshold which is employed in order to declare a subscriber a churn risk.

An ROC curve may be used to determine the value of E. To construct the ROC curve, block 1520 selects different values of E and computes the corresponding false positive rate (proportion of non-churners who were incorrectly classified as churners) and true positive rate (proportion of churners who were correctly classified as churners). Ideally, the resulting curve (FPR vs. TPR) will approach the point (0, 1), which indicates zero false positives and zero false negatives. To select the operating point, at block 1520, the value of E which produces a point on the ROC curve closest to (0,1) is found.

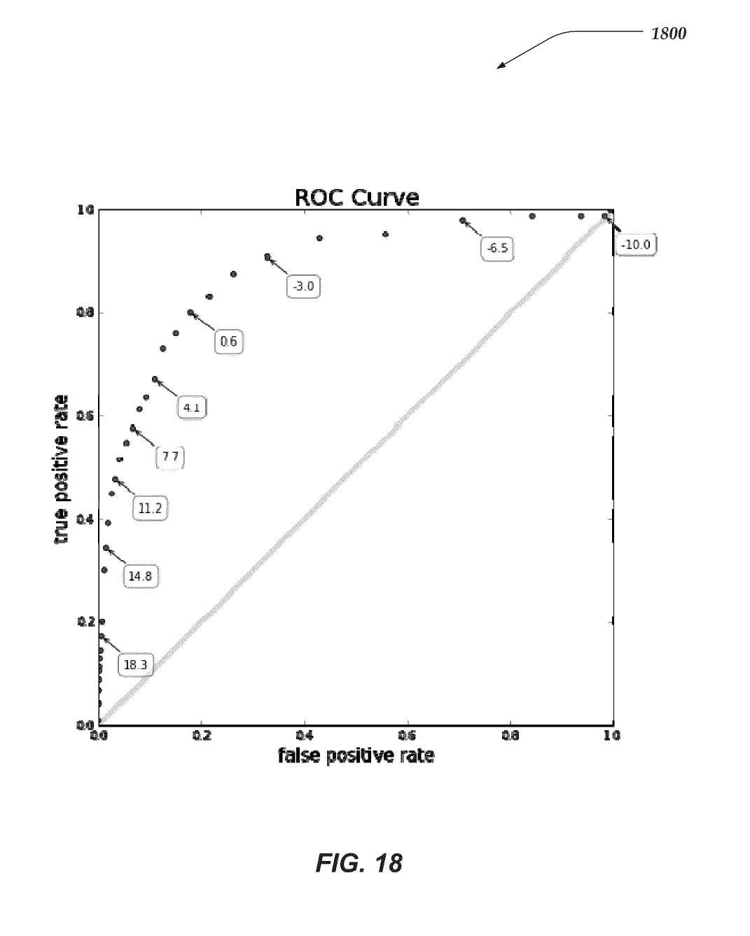

Briefly referring to FIG. 18, is one non-limiting, non-exhaustive example of a Receiver Operating Characteristic (ROC) curve useable to determine an operating point. Each point is labeled with the corresponding value of E. The operating point for this model is ε=0.6 (additional points are added to the plot if higher resolution is desired). In FIG. 18, the main feature employed in the model is daily total revenue-generating activity discretized into 5 levels and the model uses 4 hidden states. The offset parameter value with the best performance (closest to the point (0, 1)) is 0.6. AUC is 0.88 and the corresponding confusion matrix is

$$[ \begin{matrix}TP & FN \\ FP & TN\end{matrix} ] = [ \begin{matrix}200 & 50 \\ 1923 & 8783\end{matrix} ]$$

where TP, FP, TN, and FN are abbreviations for True Positive, False Positive, True Negative, and False Negative, respectively.

At block 1520, after the operating point is selected, the model is validated using the validation set. The use of this held-out data is intended to give an unbiased estimate of true performance of the model. Several standard performance metrics for classification models are considered, including AUC (area under the ROC curve) and confusion matrices. Accuracy, the proportion of correct vs. incorrect classifications is not used to measure model quality because churn is a rare event.

The predicted performance may be stored, in particular, for use later on when evaluating the performance of the model in production (e.g., as part of process 1624 in FIG. 16). Also, operational data should be statistically similar to data used during training (if it is not, it may be necessary to retrain the model) so a record of the training data sufficient to carry out such comparison may be stored. For example, the record may include a list of which customers and what time window were used, or alternatively, include a statistical profile of the data.

Churn may often be present in less than 5% of a representative sample of subscribers. This makes accuracy a poor choice for measuring model quality. Even a model with seemingly low accuracy can be used to produce a set of likely churners with many times fewer falsely labeled non-churners than a random sample (e.g., the model has produced a sample with only ¼ of the non-churners that a random sample would contain). This greatly enhances the ability of marketers to target churners at the scale necessary to impact churn rates across a modern telecom network with millions of subscribers. The fact that the model has seemingly low accuracy is merely a consequence of the natural rate of churn in the population; if churn becomes more prevalent, the same model would suddenly seem to have higher accuracy.

Process 1500 may then return to a calling process, after block 1520.

### The Model in Production

FIG. 16 shows one embodiment of a process flow useable in live production of the trained Churn and No-Churn HMMs. It is noted that many of the actions performed during the production use of the Churn/No-Churn HMM models are substantially similar to those performed to train the models. However, several actions performed during training need not be performed during production.

Briefly, process 1600 of FIG. 16 represents on process flow where a trained model is used in production to determine the current churn risk for subscribers. The model results are then appended to the common schema, and used by the contextual marketing manager discussed above to selectively send messages to subscribers based on their risk to churn.

Thus, process 1600 begins, after a start block, at block 1602, where raw customer data is received, as discussed above in conjunction with block 1502 of FIG. 15. Process 1600 then flows to block 1604, where frontend processing substantially similar to that of block 1504 of FIG. 15 is performed.

Moving next to block 1610, where the active subscriber filter performs actions substantially similar to that of the active-subscriber of FIG. 15. That is, given a start and end date, the filter identifies all subscribers who meet the chosen definition of active, based on one of the methods detailed above for Activity Levels.

Process 1600 then flows to block 1612, where the preparation of the data is also substantially similar to those actions described above in conjunction with FIG. 15. That is preparation includes for example, building sequences of discretized data, performing normalization, and so forth, however, no churn labels are computed. Indeed, this is not possible during the period in which a churn prediction has value: before the point of churn. In any event, churn labels are not required in production in order to predict churn risk. Moving next to block 1618, since the churn/no-churn HMM models are already trained and tuned, the models are retrieved and used to perform scoring of the subscribers.

That is, churn risk values are assigned to each subscriber. To provide a complete representation of the subscribers, in one embodiment, no value, or a unique value indicating such, is assigned for subscribers who did not pass through the active subscriber filter. Then, for those subscribers who passed the active subscriber filter, two numeric scores, churn index and churn index percentile, are assigned to subscribers who pass the active subscriber filter. These scores are proportional to the likelihood that the subscriber's behavioral sequence came from the churn HMM rather than the non-churn HMM.

The churn index is L_{c}−L_{nc} (or alternatively in the form of Equation (17), normalized to account for sequence length). Negative values indicate that the non-churn model more likely produced the sequence, i.e., that the subscriber is not a churn risk. The Churn index percentile, in one embodiment, may be computed only for churn risks, i.e., subscribers with a positive Churn index.

A salient feature is that higher values indicate a stronger churn risk. In addition to simply classifying subscribers as a churn risk or not, the value can be used to construct a ranked list of subscribers ordered by churn risk. In practice, the higher the score, the higher the accuracy of the churn/non-churn classification.

There may be situations where it is possible that the likelihood of a subscriber's behavioral sequence cannot be computed by the HMM model, in which case no value is assigned to the subscriber (an example of such a case is given below). As a primary use case of the churn model is to provide data to the CMP with the goal of informing population-scale messaging optimization, a small number of cases in which no churn determination is made is acceptable as it is unlikely to significantly degrade overall performance.

A churn index time series also may be recorded for each subscriber in order to store historical values from various iterations of the model in production. This enables model monitoring and comparison between different versions of the model. In particular, this enables monitoring of the current production model and its most recent predecessor. If the current production model breaks down, it can quickly be determined whether it makes sense to revert to the previous version because only the most recent version is broken or if a new pathology affecting other versions has arisen and a new model is required. It is also possible to compare the performance of the model in production to its predicted performance at training time if such data were stored, for example, as described in conjunction with Block 1520.

Thus, as an aside, as shown in FIG. 14, rather than a single churn model (such as model 1402 of FIG. 14), many models (e.g., models 1402-104 of FIG. 14) may be available in production. In some embodiments, then a model may be retrained on new data, so some current and some previous versions of one model are available. Also, several models based on different behavior sequence intervals, activity thresholds, and label sequence intervals are made simultaneously available. In effect, these offer several different definitions of churn (how active somebody needed to be in the past vs. how little activity in needed in the future). This allows for identification of a most relevant version, which is expected to vary between carriers and between plans offered by a carrier in order to construct campaigns. More significantly, it provides the contextual marketing model with a rich set of attributes, from which the most effective will be determined automatically. Thus, value placed on a particular version may depend, even within the same carrier and plan, on the specific use case (e.g., automated contextual marketing vs. manual reporting).

Returning to FIG. 16, the results of the scoring are then provided to the contextual marketing manager at Block 1622, through the common schema data storage, such that churn risk for each subscriber may be used to determine if and when to send a message to a subscriber to optimize the marketing campaign being orchestrated by the CMP.

Process 1600 moves next to block 1624, where monitoring of the mathematical performance of the churn models is performed in the production environment. This is distinct from the computational performance of the model, which is already monitored by the contextual marketing manager. The distinction between the mathematical and computation monitoring is between mathematical properties such as basic statistics of the model inputs and outputs and computational properties such as whether the model ran and completed on schedule. Monitoring consists of tracking several components and detecting anomalies. Such anomalies can indicate that the model is broken in a mathematical sense (e.g., a change in units such as moving from seconds to minutes could impact the revenue-generating activity calculation) or simply indicate that the model has become stale and that it is time to retrain (e.g., novel consumer behavior, such as a decrease in general reliance on SMS messaging, is observed as the popularity of a data service increases). These problems might not be detected by system monitoring, which would show that the model received data and produced predictions. Basic model monitoring includes, but is not limited to:
Input monitoring
   Comparison of the statistical profiles of the data passed to the Active subscriber filter at training time and in live data.
   Comparison of the statistical profiles of the data passed to the different HMMs at training time and in live data.
   Statistical profile of the live data (on its own, not in comparison to anything else)
   Comparison of the statistical profiles of churners vs. non-churners (and sub-populations as appropriate) at training and in production. Note that there is a lag in this component of several days or weeks since it is computed with data between a prediction date in the past and the current date. That is, the anomalies detected in this comparison reveal a change that occurred at the prediction date in the past, and not on the current date.
   It is possible that a discrete value will be presented to the HMM at prediction time that was not present during training Such values might not be represented by the HMM, and consequently no churn score is logged for the subscriber. Monitoring the number of such occurrences (they are typically rare) allows detection of a spike in the number that would indicate substantial new behavior and the need to retrain the model.
Output monitoring
   Comparison of the frequency of churn predicted by the model at training time and in production.
   Churn model quality metrics once sufficient time has passed to gather label data. Note that this measurement lags in the same sense as the comparison of churners to non-churners as mentioned above.
Model comparison
   Comparison of model quality metrics between the current version of a model and the last known good version of the same model. This can facilitate the decision between rolling back to the old version vs. developing a replacement.
   Comparison of model quality metrics between different families of models.

In most cases, comparison is between statistical profiles of the quantities of interest. This includes the comparison of basic statistics, such as the mean of the distribution of a variable in a test set vs. the mean in live data, through the use of appropriate statistical tools (e.g., hypothesis tests such as a t-test if the variable happens to be normally distributed). Appropriate tests for direct comparison of probability distributions also exist (e.g., the Kolmogorov-Smirnov test). One wants to demonstrate that certain quintiles of the data are close, in a statistical sense, in the two sets being compared.

Flowing to block 1626, the results of the monitoring may be used, as noted above, to indicate a need to retrain or change the churn models. The determination of whether to perform retraining may be based on any of a variety of criteria. For example, retraining may be performed on a regular interval, say every week, every month, or the like. However, retraining may also be based on some event, such as based on feedback obtained from using the churn models in production mode, as shown in FIG. 16. Retraining may also be performed based on other criteria as well. As such, the monitoring results may trigger a new iteration over process 1500 of FIG. 15.

Process 1600 then flows back to continue to receive customer data at block 1602, and to repeat the steps above, as shown in FIG. 16. While process 1600 appears to operate as an “end-less” loop, it should be understood that it may be executed according to a schedule (e.g., a process to be run daily or weekly) and it may be terminated at any time. Moreover, process 1600 may also be configured to perform asynchronously as a plurality of process 1600s. That is, a different execution of process 1600 may be performed using different churn models at block 1618, using different filter criteria, and/or even based on different service providers' subscriber bases.

It will be understood that each block of the processes, and combinations of blocks in the processes discussed above, can be implemented by computer program instructions. These program instructions may be provided to a processor to produce a machine, such that the instructions, which execute on the processor, create means for implementing the actions specified in the block or blocks. The computer program instructions may be executed by a processor to cause a series of operational steps to be performed by the processor to produce a computer-implemented process such that the instructions, which execute on the processor to provide steps for implementing the actions specified in the block or blocks. The computer program instructions may also cause at least some of the operational steps shown in the blocks to be performed in parallel. Moreover, some of the steps may also be performed across more than one processor, such as might arise in a multiprocessor computer system. In addition, one or more blocks or combinations of blocks in the illustration may also be performed concurrently with other blocks or combinations of blocks, or even in a different sequence than illustrated without departing from the scope or spirit of the subject innovation.

Accordingly, blocks of the illustration support combinations of means for performing the specified actions, combinations of steps for performing the specified actions and program instruction means for performing the specified actions. It will also be understood that each block of the illustration, and combinations of blocks in the illustration, can be implemented by special purpose hardware based systems, which perform the specified actions or steps, or combinations of special purpose hardware and computer instructions.

The above specification, examples, and data provide a complete description of the manufacture and use of the composition of the subject innovation. Since many embodiments of the subject innovation can be made without departing from the spirit and scope of the subject innovation, the subject innovation resides in the claims hereinafter appended.

1. A network device, comprising:
a transceiver to send and receive data over a network; and
one or more processors that are operative to perform actions, including:
training a churn model that uses dynamic state-spacing modeling to represent information about previous first sequential behavior activities of multiple first subscribers of a telecommunications service provider involving use of telecommunications functionality of a telecommunications service provider, wherein the multiple first subscribers subsequently terminate use of the telecommunications functionality after the first sequential behavior activities;
training a non-churn model that uses dynamic state-spacing modeling to represent information about previous second sequential behavior activities of multiple second subscribers of the telecommunications service provider involving use of the telecommunications functionality, wherein the multiple second subscribers are distinct from the multiple first subscribers and do not subsequently terminate use of the telecommunications functionality after the second sequential behavior activities, and wherein the non-churn model is separate from the churn model;
receiving, from the telecommunications service provider, data about behavior of a plurality of subscribers of the telecommunications service provider;
applying an active-subscriber filter to select a subset of the plurality of subscribers that satisfy a selected Activity Level;
employing the trained churn model to determine, for each subscriber in the subset, a first proportional likelihood that a behavioral sequence of the subscriber matches the first sequential behavior activities of the trained churn model;
employing the trained non-churn model to determine, for each subscriber in the subset, a second proportional likelihood that the behavioral sequence of the subscriber matches the second sequential behavior activities of the trained non-churn model;
comparing, for each subscriber in the subset, the determined first and second proportional likelihoods for the subscriber to identify whether the behavioral sequence of the subscriber is more similar to the first sequential behavior activities of the multiple first subscribers for the trained churn model or to the second sequential behavior activities of the multiple second subscribers for the trained non-churn model, and determining a churn risk value for the subscriber based on the determined first proportional likelihood and on the determined second proportional likelihood; and
sending, for one or more subscribers that are selected from the subset based at least in part on the determined churn risk values for the one or more subscribers, messages over one or more computer networks to one or more client devices of the one or more subscribers to influence future actions of the one or more subscribers related to churn for the telecommunications service provider.

2. The network device of claim 1 wherein the sending of the messages to the one or more subscribers to influence future actions of the one or more subscribers is performed to decrease a rate of churn within an active subscriber base of the telecommunications service provider.

3. The network device of claim 1 wherein the one or more processors are further operative to, before the sending of the messages to the one or more subscribers, perform selecting of the one or more subscribers, to be recipients of the messages, from the subset based on the determined churn risk values for the one or more subscribers.

4. The network device of claim 1 wherein the selected Activity Level is computed based on a first time window preceding a given date and on a second time window after the given date, and wherein the Activity Level is selected (a) based on a threshold on a provider reported status that is time-averaged over the first and second time windows, (b) based on a trend in a time-averaged provider reported status that decreases from the first time window to the second time window, (c) based on a threshold on account and usage data that is time-averaged over the first and second time windows, (d) based on a clustering on a low-pass wavelet filtered provider reported status, (e) based on a rule set, or (f) based on any combination of two or more of (a)-(e).

5. The network device of claim 1 wherein at least one of the trained churn model or the trained non-churn model is calibrated based on a Receiver Operating Characteristic (ROC) curve to select a threshold value used to declare that a subscriber is a churn risk.

6. The network device of claim 1 wherein at least one of the trained churn model or the trained non-churn model is implemented within a Hidden Markov Model framework.

7. The network device of claim 1 wherein the one or more processors are further operative to profile the trained churn and non-churn models to enable reporting and monitoring capability to the telecommunications service provider.

8. The network device of claim 1 wherein the employing of the trained churn and non-churn models includes applying wavelet filtering to quantized variables of each subscriber in the subset to determine activity thresholds.

9. The network device of claim 1 wherein the one or more processors are further operative to employ contextual data to separate the subset of subscribers into multiple segments, to build individual behavioral sub-models for each of the multiple segments, and to select, for each of the subscribers in the subset, one of the multiple segments to which the subscriber belongs, and wherein, for each subscriber in the subset, the employing of the trained churned and non-churned models includes using the individual behavioral sub-models for the segment selected for the subscriber.

10. The network device of claim 1 wherein the one or more processors are further operative to receive data from at least one external source about the plurality of subscribers, and wherein at least one of the applying of the active-subscriber filter or the employing of the trained churn model or the employing of the trained non-churn model is based in part on the received data.

11. The network device of claim 10 wherein the one or more processors are further operative to employ dynamic social network features of at least some of the received data to construct the behavioral sequence of each subscriber in the subset.

12. A non-transitory computer-readable storage device having computer-executable instructions stored thereon that, in response to execution by a processor unit, cause the processor unit to perform operations including:
training a churn model that uses dynamic state-spacing modeling to represent information about previous first sequential behavior activities of multiple first subscribers of a network provider who subsequently terminate use of a product or service of the network provider;
training a non-churn model that uses dynamic state-spacing modeling to represent information about previous second sequential behavior activities of multiple second subscribers of the network provider who do not subsequently terminate use of the product or service of the network provider, wherein the multiple second subscribers are distinct from the multiple first subscribers, and wherein the non-churn model is separate from the churn model;
receiving, from the network provider, data about behavior of a plurality of subscribers of the network provider;
employing the trained churn model to determine, for a subscriber from the plurality of subscribers, a first proportional likelihood that a behavioral sequence of the subscriber matches the first sequential behavior activities of the trained churn model;
employing the trained non-churn model to determine a second proportional likelihood that the behavioral sequence of the subscriber matches the second sequential behavior activities of the trained non-churn model;
comparing the determined first and second proportional likelihoods to identify that the behavioral sequence of the subscriber is more similar to the first sequential behavior activities of the multiple first subscribers for the trained churn model than to the second sequential behavior activities of the multiple second subscribers for the trained non-churn model; and
sending, based at least in part on identifying that the behavioral sequence of the subscriber is more similar to the first sequential behavior activities of the multiple first subscribers for the trained churn model, one or more messages over one or more networks to a client device of the subscriber to influence future actions of the subscriber related to churn for the network provider.

13. The non-transitory computer-readable storage device of claim 12 wherein the sending of the one or more messages decreases a Key Performance Indicator based on a rate of churn within an active subscriber base of the network provider.

14. The non-transitory computer-readable storage device of claim 12 wherein the computer-executable instructions further cause the processor unit to, before the sending of the one or more messages, determine a churn risk value for the subscriber based at least in part on the determined first and second proportional likelihoods, and select the subscriber as a recipient of the messages based on the determined churn risk value.

15. The non-transitory computer-readable storage device of claim 12 wherein the trained churn and non-churn models are calibrated based on a Receiver Operating Characteristic (ROC) curve to select a threshold value used to declare that a subscriber is a churn risk.

16. The non-transitory computer-readable storage device of claim 12 wherein the trained churn and non-churn models are implemented within a Hidden Markov Model framework.

17. The non-transitory computer-readable storage device of claim 12 wherein the computer-executable instructions further cause the processor unit to apply an active-subscriber filter to select a subset of the plurality of subscribers that satisfy a selected activity level, wherein the employing of the trained churn model and the employing of the trained non-churn model and the comparing is performed for each subscriber of the subset, and wherein the trained churn and non-churn models further apply wavelet filtering to quantized variables of each subscriber in the subset to determine activity thresholds.

18. The non-transitory computer-readable storage device of claim 12, wherein the computer-executable instructions further cause the processor unit to apply an active-subscriber filter to select a subset of the plurality of subscribers that satisfy a selected activity level, to employ contextual data to separate the subset of subscribers into multiple segments, to build individual behavioral sub-models for each of the multiple segments, and to select, for each of the subscribers in the subset, one of the multiple segments to which the subscriber belongs, wherein the employing of the trained churn model and the employing of the trained non-churn model is performed for each subscriber of the subset, and wherein, for each subscriber in the subset, the trained churned and non-churned models employed for the subscriber are from the individual behavioral sub-models for the segment selected for the subscriber.

19. The non-transitory computer-readable storage device of claim 12 wherein the computer-executable instructions further cause the processor unit to employ dynamic social network features of at least some data from the network provider 1 regarding activities of the plurality of subscribers to construct a behavioral sequence of each subscriber in the subset.

20. A system, comprising:
a non-transitory data storage device; and
one or more special purpose computer devices that access and store data on the data storage device and employ at least one processor to perform actions, including:
training a churn model to represent information about previous first sequential behavior activities of multiple first subscribers of a network provider who subsequently terminate use of a product or service of the network provider;
training a non-churn model to represent information about previous second sequential behavior activities of multiple second subscribers of the network provider who do not subsequently terminate use of the product or service of the network provider, wherein the multiple second subscribers are distinct from the multiple first subscribers, and wherein the non-churn model is separate from the churn model;
receiving, from the network provider, data about behavior of a plurality of subscribers of the network provider;
employing the trained churn model to determine, for a subscriber from the plurality of subscribers, a first proportional likelihood that a behavioral sequence of the subscriber matches the first sequential behavior activities of the trained churn model;
employing the trained non-churn model to determine a second proportional likelihood that the behavioral sequence of the subscriber matches the second sequential behavior activities of the trained non-churn model;
comparing the determined first and second proportional likelihoods to identify that the behavioral sequence of the subscriber is more similar to the first sequential behavior activities of the multiple first subscribers for the trained churn model than to the second sequential behavior activities of the multiple second subscribers for the trained non-churn model; and
sending, based at least in part on identifying that the behavioral sequence of the subscriber is more similar to the first sequential behavior activities of the multiple first subscribers for the trained churn model, one or more messages to the subscribers to influence future actions of the subscriber related to churn for the network provider.

21. The system of claim 20 wherein the at least one processor is further employed to use dynamic social network features of at least some data from the network provider regarding activities of the plurality of subscribers to construct the behavioral sequence of the subscriber.

22. The system of claim 20 wherein the at least one processor is further employed to receive data from at least one external source about the plurality of subscribers, and wherein at least one of the employing of the trained churn or the employing of the non-churn model is based in part on the received data.

23. The system of claim 20, wherein the at least one processor is further configured to apply an active-subscriber filter to select a subset of the plurality of subscribers that satisfy a selected activity level, to employ contextual data to separate the subset of subscribers into multiple segments, to build individual behavioral sub-models for each of the multiple segments, and to select, for each of the subscribers in the subset, one of the multiple segments to which the subscriber belongs, wherein the employing of the trained churn model and the employing of the trained non-churn model is performed for each subscriber of the subset, and wherein, for each subscriber in the subset, the trained churned and non-churned models employed for the subscriber are from the individual behavioral sub-models for the segment selected for the subscriber.

24. The system of claim 20 wherein the at least one processor is further configured to apply an active-subscriber filter to select a subset of the plurality of subscribers that satisfy a selected activity level, and wherein the trained churn and non-churn models further apply wavelet filtering to quantized variables of each subscriber in the subset to determine activity thresholds.
